(19) United States
(12) Patent Application Publication
(10) Pub. No.: US 2025/0380280 A1
(43) Pub. Date: Dec. 11, 2025

(54) SIDELINK BEAM MANAGEMENT - SL BEAM MANAGEMENT PROCEDURES

(71) Applicant: Fraunhofer-Gesellschaft zur Förderung der angewandten Forschung e.V., München (DE)

(72) Inventors: Thomas WIRTH, Berlin (DE); Thomas FEHRENBACH, Berlin (DE); Baris GÖKTEPE, Berlin (DE); Thomas SCHIERL, Berlin (DE); Cornelius HELLGE, Berlin (DE)

(21) Appl. No.: 19/300,996

(22) Filed: Aug. 15, 2025

Related U.S. Application Data
(63) Continuation of application No. PCT/EP2024/053341, filed on Feb. 9, 2024.

(30) Foreign Application Priority Data
Feb. 16, 2023 (EP) 23157109.2

(51) Int. Cl. H04W 72/25; H04B 7/06; H04L 5/00

(52) U.S. Cl. CPC H04W 72/25; H04B 7/06954; H04L 5/0098

(57) ABSTRACT

A user device, UE, for a wireless communication network is described. The UE is a sidelink, SL, UE, and is to communicate with one or more further SL-UEs over a sidelink, SL, using more than one antenna or antenna element. The UE is served by a base station of the wireless communication network. The UE is to be assisted by the base station for one or more beam management procedures.

### CROSS-REFERENCE TO RELATED APPLICATIONS

This application is a continuation of copending International Application No. PCT/EP2024/053341, filed Feb. 9, 2024, which is incorporated herein by reference in its entirety, and additionally claims priority from European Application No. 23157109.2, filed Feb. 16, 2023, which is also incorporated herein by reference in its entirety.

### TECHNICAL FIELD

The present invention concerns the field of wireless communication systems or networks, more specifically, to a direct communication between user devices over a sidelink using two or more antennas for focusing a wireless signal or beam by a transmitting device towards a receiving device, which is also known as beamforming. Embodiments concern the management of the one or more beams when communicating over a sidelink, SL, e.g., a sidelink beam management employing a beam management report, BMR, or a sidelink beam management employing network assisted (centralized) beam management procedures or non-network assisted (decentralized) beam management procedures.

### BACKGROUND OF THE INVENTION

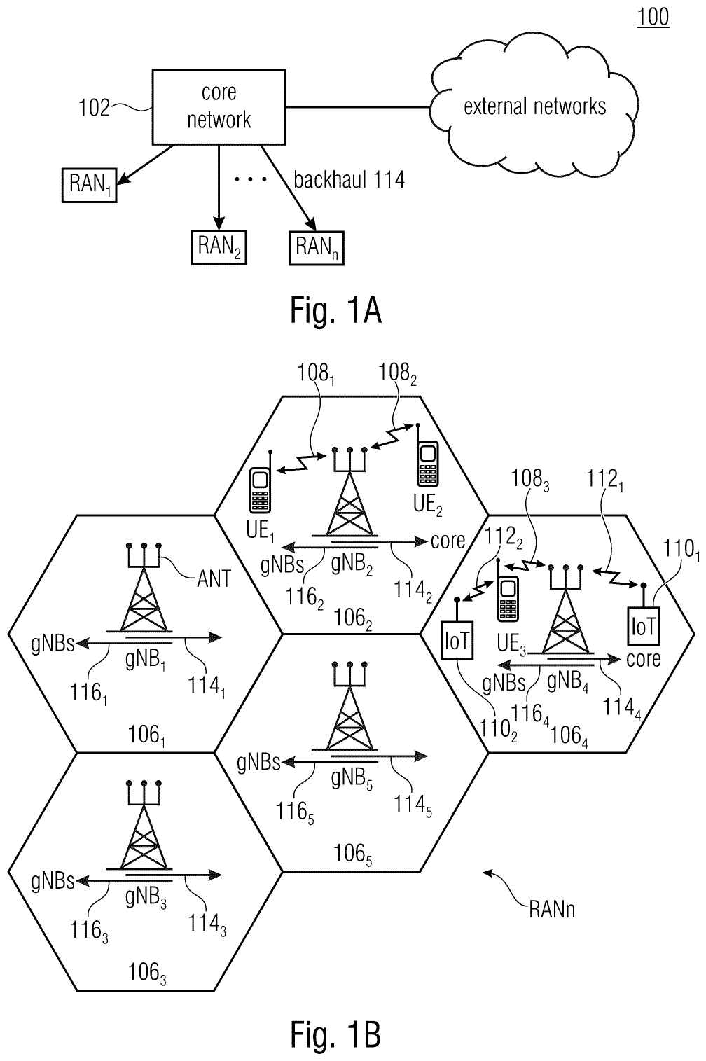

FIG. 1 is a schematic representation of an example of a terrestrial wireless network 100 including, as is shown in FIG. 1(A), the core network 102 and one or more radio access networks RAN₁, RAN₂, . . . RAN_{N}. FIG. 1(B) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(B) shows an exemplary view of five cells, however, the RANₙ may include more or less such cells, and RANₙ may also include only one base station. FIG. 1(B) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(B) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1(B) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 1(B) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st}-stage SCI, and optionally, a second control region which contains a second part of control information, also referred to as the 2^{nd}-stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with 3GPPs LTE, LTE-Advanced, LTE-Advanced Pro, or the 5G or 3GPPs NR, New Radio, or within LTE-U, LTE Unlicensed or NR-U, New Radio Unlicensed, which is specified within the LTE and within NR specifications.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro or 5G or NR, New Radio.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are necessarily outside one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

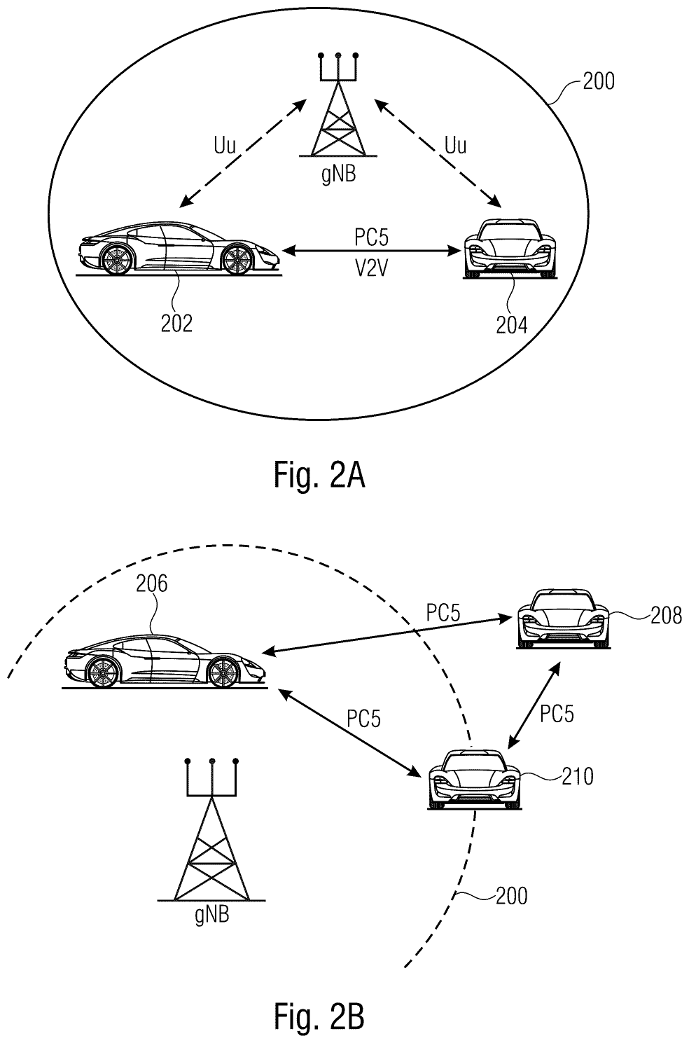

FIG. 2(A) is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a Mode 1 configuration in NR V2X or as a mode 3 configuration in LTE V2X. Thus, in Mode 1, a S-UE, e.g., UE 202 is connected via Uu interface to the gNB, and the gNB coordinates the resources for UE 202 be used to transmit control and/or data to another UE, e.g., UE 204, via a SL interface, which is referred to in NR as PC5.

FIG. 2(B) is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a Mode 2 configuration in NR V2X or as a Mode 4 configuration in LTE V2X. As mentioned above, the scenario in FIG. 2(B) which is the out-of-coverage scenario does not necessarily mean that the respective Mode 2 UEs in NR or mode 4 UEs in LTE are outside of the coverage 200 of a base station, rather, it means that the respective Mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2(A), in addition to the NR Mode 1 or LTE Mode 3 UEs 202, 204 also NR Mode 2 or LTE mode 4 UEs 206, 208, 210 are present. In addition, FIG. 2(B), schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210. Thus, the SL-UEs, e.g., UEs 206-210, need not to have a connectivity to the gNB, and perform a sensing & access resource allocation or a random access-based resource allocation, e.g., when transmitting from UE 206 to UE 208. Nevertheless, basic configurations need to be available for the UEs 206-210, in order to successfully exchange data. This information may be pre-configured or may be configured while a UE is within coverage of the gNB. For this the gNB may provide a basic configuration, e.g., basic information, which may be transported via a broadcast channel, e.g., using system information blocks (SIBs). The BS may also assist Mode 2 UEs to provide basic information on which resource pool (RP) is to be used or may act as a synchronization source.

Although FIG. 2(A) and FIG. 2(B) illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In general, Mode 1 refers to a RAN-supported operation including base stations, whereas Mode 2 refers to an autonomous mode, where UEs communicate directly without support of a base station. In the context of WiFi, the coordination done by a WiFi access point, AP, may be referred to a similar operation as Mode 1, whereas Mode 2 translates to the WiFi autonomous mode. In the latter, two WiFi devices may directly communicate with each other without assistance by the WiFi AP.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

The 5G/NR network may operate in a plurality of frequency ranges, e.g., in a first, low frequency range, like frequency range 1, FR1, and in a second, high frequency range, like frequency range 2, FR2. FR1 includes the sub-6 GHz frequency bands, some of which are used by previous standards. FR2 includes operational frequencies that have been allocated to 5G in the mmWave region, e.g., above 24 GHz or from 24 GHz to 71 GHz. These bands aim to provide high performance 5G as large amounts of bandwidths are available for use. Networks operating on FR2 bands may achieve gigabit data rates or even higher with extremely low latency.

However, operating at high frequencies, like in FR2, comes together with some constraints regarding a radiation of radio signals. For example, a penetration of radio signals at these frequencies is worse when compared to operation in FR1, e.g., frequencies below 6 GHz. Therefore, it is foreseen to utilize Multiple Input Multiple Output, MIMO, techniques to improve transmission and reception of these radio signals. For example, for eMBB services, the Uu interface already supports operations within FR2 and has defined beam management techniques including beam pairing during an initial access, beam maintenance as well as beam recovery procedures. Note that beam maintenance may include tracking of a beam, channel state estimation and/or rank estimation of a received beam, best path or direct path estimation of a received beam.

While some the basic techniques known from the Uu interface may be adopted for a SL communication, one has to keep in mind that there are the above-mentioned operational modes, namely Mode 1 and Mode 2. While a gNB may assist a SL-UE with the beam management in Mode 1, in Mode 2, SL-UEs have to perform the beam management without any assistance from a base station or, more generally, from the network side. Also, a base station comprises larger antenna apertures, more sensitive receivers and more powerful transmit chains and may thus provide more accurate assistance information. In Mode 2, the SL-UEs have to rely on their own hardware, which typically has larger impairments due to high integration of devices, hardware costs, as well as power limitations at a handheld device.

Another constraint in both Mode 1 and Mode 2 is that the link of relevance for device-to-device communication is the sidelink, the radio link between SL-UEs. Thus, although the gNB may have improved hardware capabilities, it only receives radio signals from the UEs via the uplink using the Uu interface, so that it does not know the characteristics of the direct link between the UEs, which might be obstructed. Thus, the gNB or base station is only capable to estimate certain characteristics of the direct link between UEs, or alternatively, may request information on the sidelink characteristics from a certain UE, which had previously conducted measurements on the sidelink radio channel. This type of measurement reports may be obtained by a base station and may be used for assistance in case of a Mode 1 sidelink operation. However, such measurement reports cause a substantial signaling overhead. Also the measurement reports may be outdated so that any beam management assistance provided by the base station may not be reliable or useful.

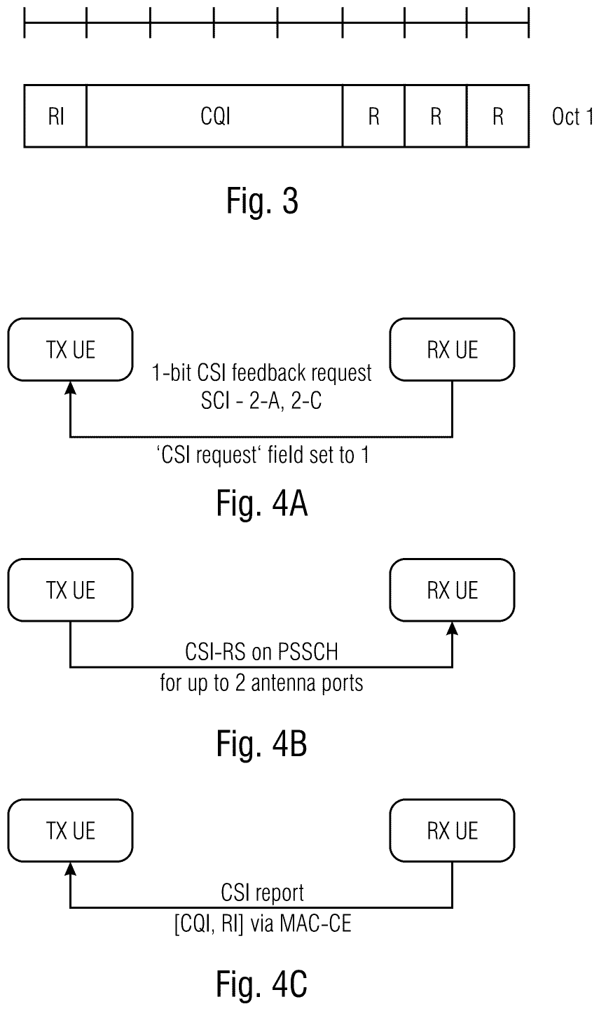

In conventional approaches, the beam management is usually based on the channel state information, CSI, exchanged between the communicating entities. However, compared to the CSI feedback on the Uu link, only a rudimentary CSI framework exists on the sidelink which may be used to transmit a CSI report between two communicating UEs via the SL or PC5 interface. Conventionally, the CSI transmitted on the sidelink only contains a channel quality index, CQI, of a CQI table defined in the 3GPP technical specification, which is calculated according to a rank indicator, RI, and a target error probability, e.g., 0.1 or 0.00001. Since only two antennas are supported in the sidelink, the CQI is only calculated for RI=1 and RI=2, and the CSI report contains 1-bit indicating the RI for which the CQI has been calculated. FIG. 3 illustrates a sidelink CSI report, with the size of 8-bits=1 octet, which is transmitted via a Medium Access Control layer Control Element, MAC CE, embedded in the PSSCH (RI=rank indicator, CQI=channel quality index, R=reserved bit as described in TS 38.321 V17.3.0 (2023-01).

FIG. 4 illustrates a basic CSI reporting mechanism between a transmitting SL-UE, referred to as TX-UE in the figure, and a receiving SL-UE, referred to as RX-UE. Initially, as is illustrated in FIG. 4(A), the RX-UE triggers a CSI report to be provided by the TX-UE, for example by sending in a sidelink control information, SCI, like a SCI 2-A or SCI 2-C, a one-bit CSI feedback request by setting the corresponding CSI request field in the SCI to 1. Responsive to receiving the CSI feedback request, the TX-UE transmits respective reference signals, the CSI-RS, on the PSSCH for up to two antenna ports, as illustrated in FIG. 4(B). The RX-UE measures the CSI-RS received on the PSSCH and creates the CSI report which may be forwarded to the TX-UE, as is illustrated in FIG. 4(C), e.g., in the form of the MAC CE illustrated in FIG. 3. The procedures for reporting the SL CSI are defined in TS 38.214 (V17.4.0, section 8.5). This specification supports aperiodic transmissions of CSI reference symbols, CSI-RS, with an aperiodic CSI reporting being triggered by a SCI. For the CSI reporting a wideband CSI reporting is supported, and a wideband CQI is supported for a single code word for the entire CSI reporting band. The CQI is calculated conditioned on the reported rank, RI. However, the current specification for sidelink CSI does not support any interference measurements nor any sub-band CQI reporting.

It is noted that the information in the above section is only for enhancing the understanding of the background of the invention and, therefore, it may contain information that does not form conventional technology that is already known to a person of ordinary skill in the art.

Starting from the above, there may be a need for improvements or enhancements of beam management on the sidelink in a wireless communication system or network.

### SUMMARY

An embodiment may have a user device, UE, for a wireless communication network, wherein the UE is a sidelink, SL, UE, and is to communicate with one or more further SL-UEs over a sidelink, SL, using more than one antenna or antenna element, wherein the UE is served by a base station of the wireless communication network, and wherein the UE is to be assisted by the base station for one or more beam management procedures.

Another embodiment may have a base station for a wireless communication network, wherein the base station is to serve a plurality of sidelink UEs, SL-UEs, communicating with each other over a sidelink, SL, using beamforming, and wherein the base station is to assist one or more of the SL-UEs in beam management procedures.

Another embodiment may have a user device, UE, for a wireless communication network, wherein the UE is a sidelink, SL, UE, and is to communicate with one or more further SL-UEs over a sidelink, SL, using more than one antenna or antenna elements, wherein the UE is to perform beam sweeping using a beam sweeping signal.

Another embodiment may have a user device, UE, for a wireless communication network, wherein the UE is a sidelink, SL, UE, and is to communicate with one or more further SL-UEs over a sidelink, SL, using more than one antenna or antenna elements, wherein the UE is to receive from at least one of the further SL-UEs a beam sweeping signal.

Another embodiment may have a wireless communication network, having: a plurality of sidelink UEs, SL-UEs, communicating with each other over a sidelink, SL, using more than one antenna, e.g., using beamforming, the plurality of SL-UEs having a first inventive SL-UE as mentioned above and a second inventive SL-UE as mentioned above, wherein the first SL-UE is to perform beam sweeping using a beam sweeping signal and transmit a communication request within the beam sweeping signal.

Another embodiment may have a user device, UE, for a wireless communication network, wherein the UE is a sidelink, SL, UE, and is to communicate with one or more further SL-UEs over a sidelink, SL, using more than one antenna or antenna elements, wherein the UE is to communicate with at least one of the further SL-UEs over the sidelink, SL, using matching beams of the UE and the further SL-UE, and wherein, responsive to a certain event, the UE is to perform a beam adjustment, e.g., such that a matching of the beam of the UE and the further SL-UE is maintained.

Another embodiment may have a wireless communication network having: a plurality of sidelink UEs, SL-UEs, communicating with each other over a sidelink, SL, the plurality of SL-UEs having a first inventive SL-UE as mentioned above and a second SL-UE communicating with each other over the SL using matching beams transmitted by the first and second SL-UEs, and wherein, responsive to a certain event, one or both of the first and second SL-UEs are to perform a beam adjustment such that a matching of the beams transmitted by the first and second SL-UEs is maintained.

Another embodiment may have a wireless communication system, e.g., a 3^{rd} Generation Partnership Project, 3GPP, system or a WiFi communication system, having the inventive user device, UE, and/or the network entity as mentioned above.

According to another embodiment, a method for operating a user device, UE, for a wireless communication network may have the steps of: communicating, by the UE which is a sidelink, SL, UE, SL-UE, being served by a base station of the wireless communication network, with one or more further SL-UEs over a sidelink, SL, using more than one antenna or antenna element, and assisting the UE, by the base station, with one or more beam management procedures.

According to another embodiment, a method for operating a base station for a wireless communication network may have the steps of: serving, by the base station, a plurality of sidelink UEs, SL-UEs, communicating with each other over a sidelink, SL, using beamforming, and assisting, by the base station, one or more of the SL-UEs in beam management procedures.

According to another embodiment, a method for operating a user device, UE, for a wireless communication network may have the steps of: communicating, by the UE which is a sidelink, SL, UE, SL-UE, with one or more further SL-UEs over a sidelink, SL, using more than one antenna or antenna element, and performing, by the UE, a beam sweeping using a beam sweeping signal.

According to another embodiment, a method for operating a user device, UE, for a wireless communication network may have the steps of: communicating, by the UE which is a sidelink, SL, UE, SL-UE, with one or more further SL-UEs over a sidelink, SL, using more than one antenna or antenna element, and receiving, by the UE, from at least one of the further SL-UEs a beam sweeping signal.

According to another embodiment, a method for operating a user device, UE, for a wireless communication network may have the steps of: communicating, by the UE which is a sidelink, SL, UE, SL-UE, with one or more further SL-UEs over a sidelink, SL, using more than one antenna or antenna element, wherein the UE communicates with at least one of the further SL-UEs over the sidelink, SL, using matching beams of the UE and the further SL-UE, and responsive to a certain event, performing, by the UE a beam adjustment, e.g., such that a matching of the beam of the UE and the further SL-UE is maintained.

Another embodiment may have a non-transitory computer program product having a computer readable medium storing instructions which, when executed on a computer, perform any of the inventive methods as mentioned above.

### BRIEF DESCRIPTION OF THE INVENTION

Embodiments of the present invention are now described in further detail with reference to the accompanying drawings:

FIGS. 1(A)-(B) illustrate a wireless communication network, wherein FIG. 1(A) is a schematic representation of an example of a terrestrial wireless network, and FIG. 1(B) is a schematic representation of an example of a radio access network, RAN;

FIG. 2(A) is a schematic representation of an in-coverage scenario;

FIG. 2(B) is a schematic representation of an out-of-coverage scenario;

FIG. 3 illustrates an example of a conventional sidelink CSI report;

FIGS. 4(A)-(C) illustrate an example of a conventional, basic CSI reporting mechanism;

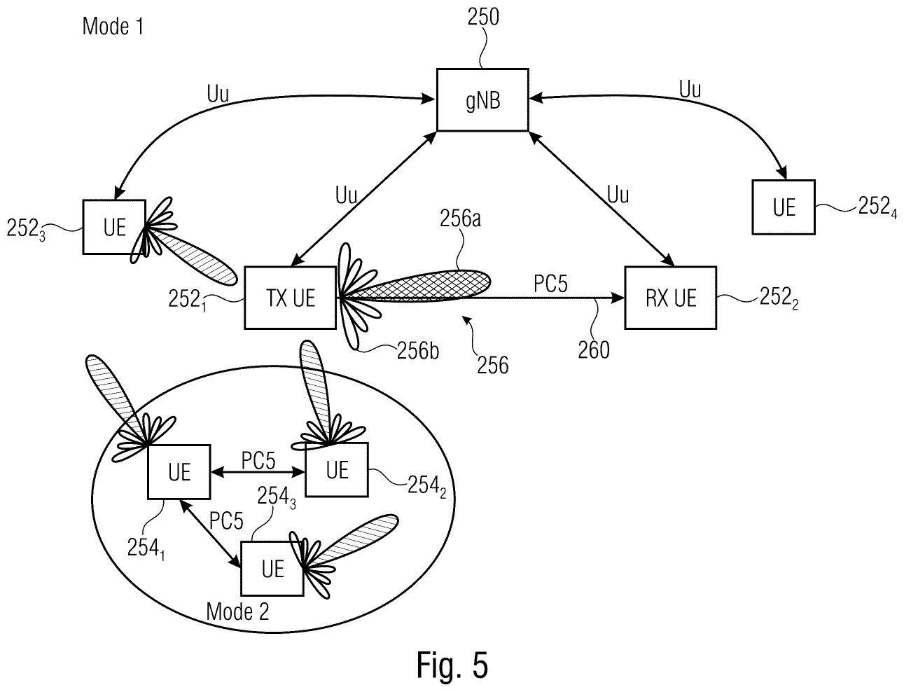

FIG. 5 illustrates an example of a wireless communication system, similar to the one illustrated in FIG. 1, including a base station and multiple SL-UEs using beamforming;

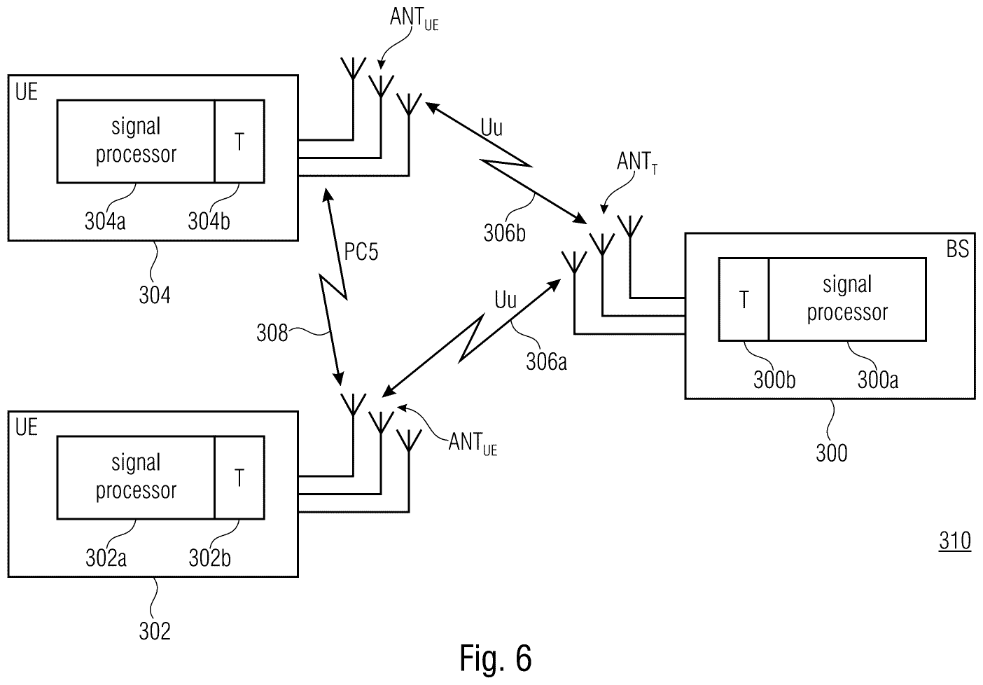

FIG. 6 is a schematic representation of a wireless communication system including a transmitter, like a base station, and one or more receivers, like user devices, UEs, implementing embodiments of the present invention;

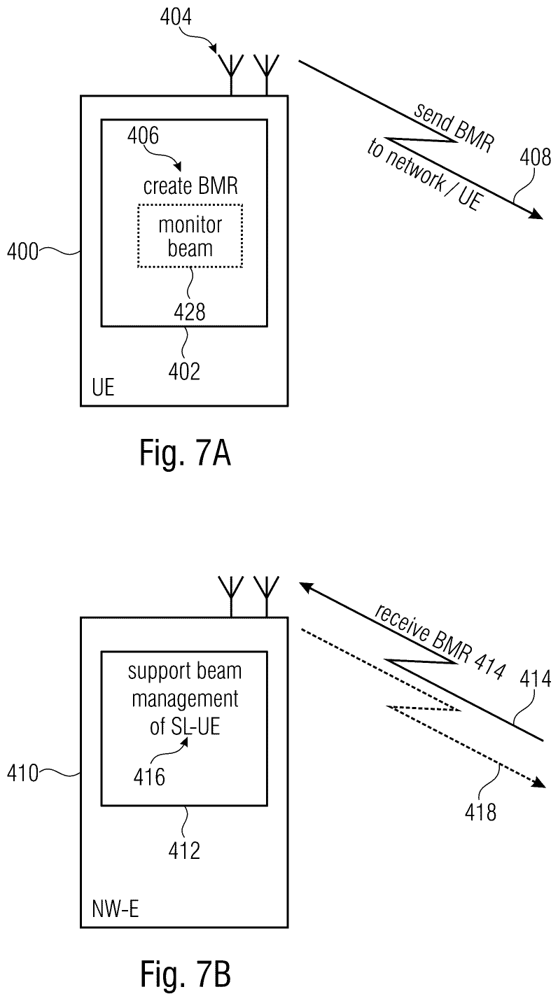

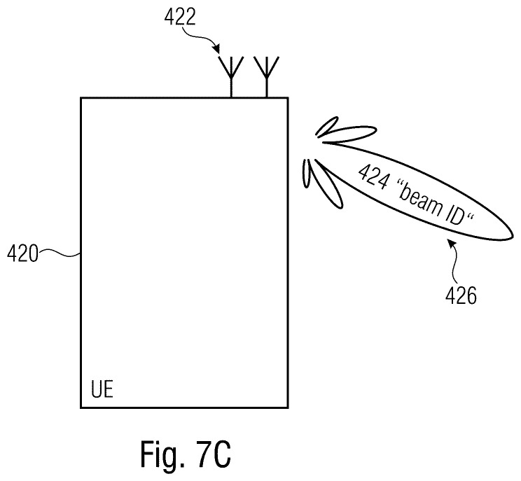

FIG. 7 illustrates embodiments of a first aspect of the present invention, more specifically FIG. 7(A) illustrates a UE according to embodiments of the first aspect providing a beam management report, FIG. 7(B) illustrates a network entity according to embodiments of the first aspect performing beam management using the BMR, and FIG. 7(C) illustrates a user device according to embodiments of the first aspect identifying its beams for allowing the generation of the BMR;

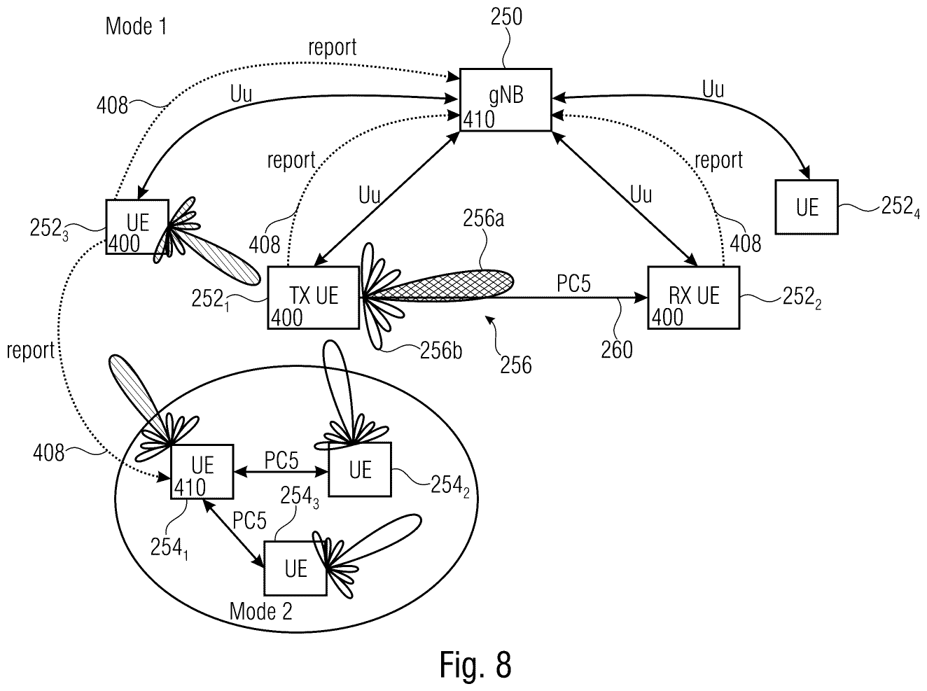

FIG. 8 illustrates the system of FIG. 5 in which embodiments according to embodiments of the first aspect of the present invention are implemented;

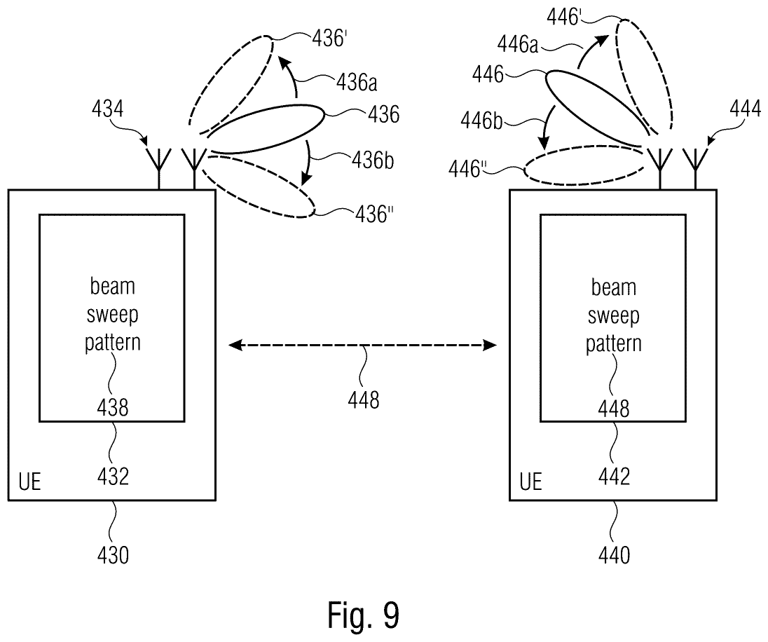

FIG. 9 illustrates an embodiment of a user device for a wireless communication network in accordance with a second aspect of the present invention;

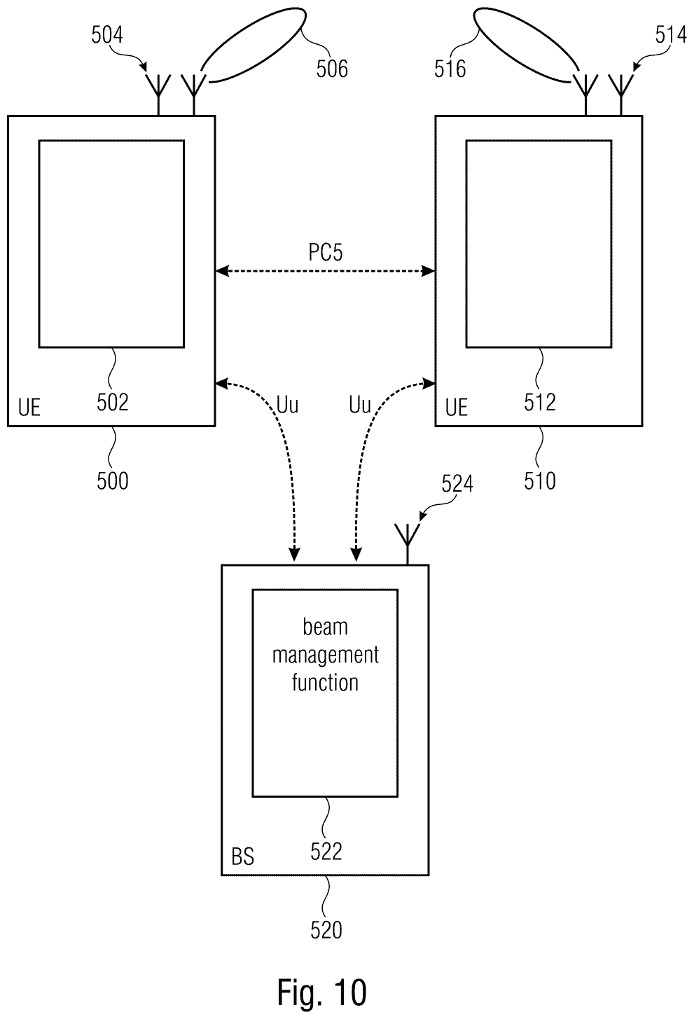

FIG. 10 illustrates network or network-side assisted beam management procedures for sidelink UEs in accordance with embodiments of a third aspect of the present invention;

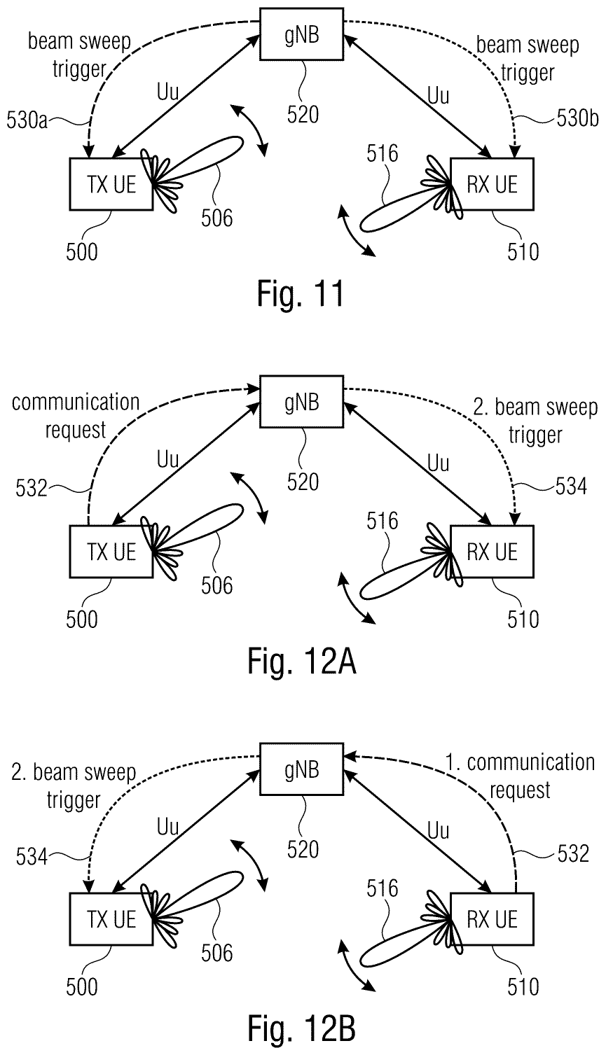

FIG. 11 illustrates an embodiment of the third aspect of the present invention for a beam sweep trigger to be performed during sidelink discovery or data exchange;

FIGS. 12(A)-(B) illustrate embodiments of the third aspect of the present invention for initiating or triggering a beam sweep by a SL-UE having a communication request;

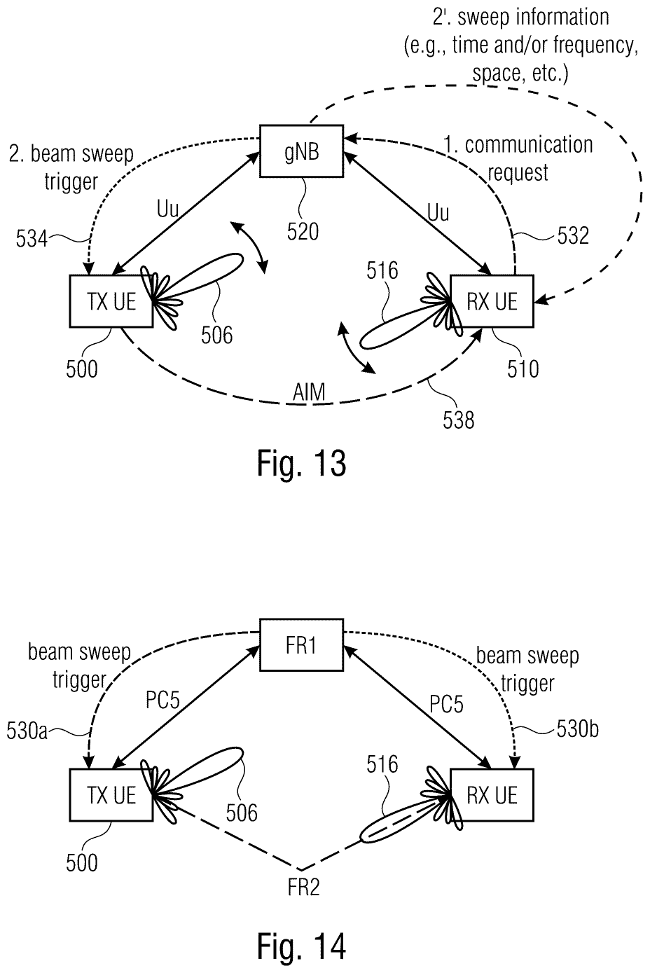

FIG. 13 illustrates an embodiment of the third aspect of the present invention distributing, responsive to a communication request, a beam sweep configuration among the SL-UEs;

FIG. 14 illustrates an embodiment of the third aspect of the present invention performing a sidelink communication and a beam management in different frequency bands;

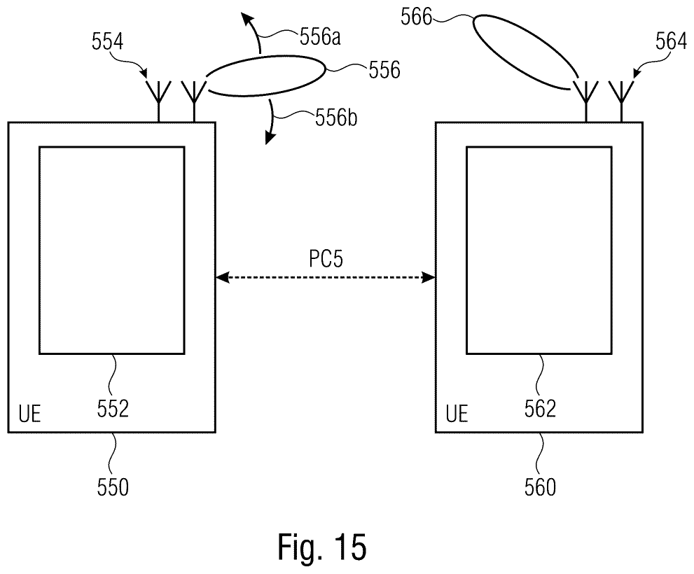

FIG. 15 illustrates non-network assisted or decentralized beam management procedures for sidelink UEs in accordance with embodiments of the third aspect of the present invention;

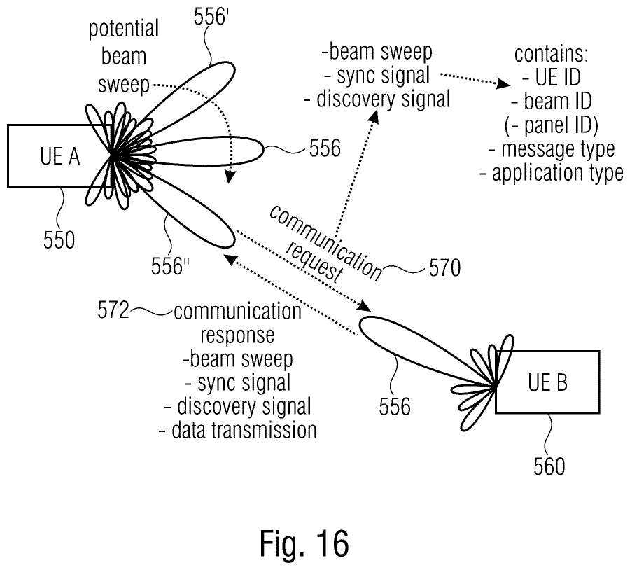

FIG. 16 illustrates an embodiment of the third aspect of the present invention performing a decentralized beam management among SL-UEs;

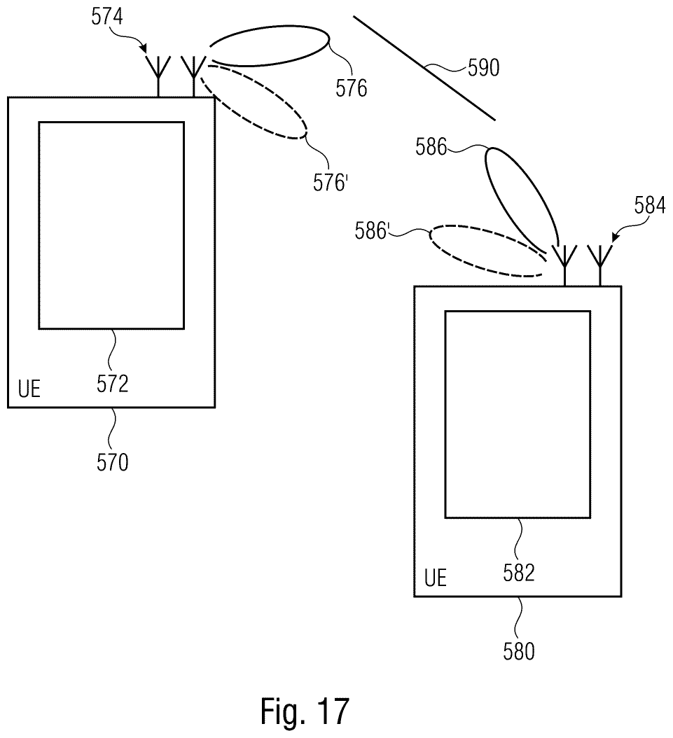

FIG. 17 illustrates an embodiment of the third aspect of the present invention concerning a decentralized beam management being performed responsive to a certain event;

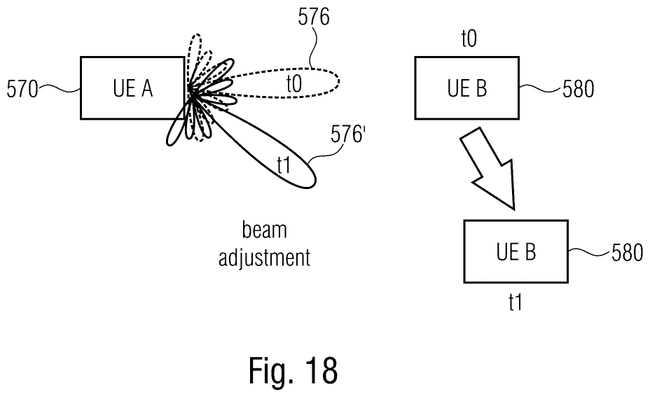

FIG. 18 illustrates an embodiment of the third aspect of the present invention of a decentralized beam adjustment being performed when SL-UEs are moving relative to each other; and

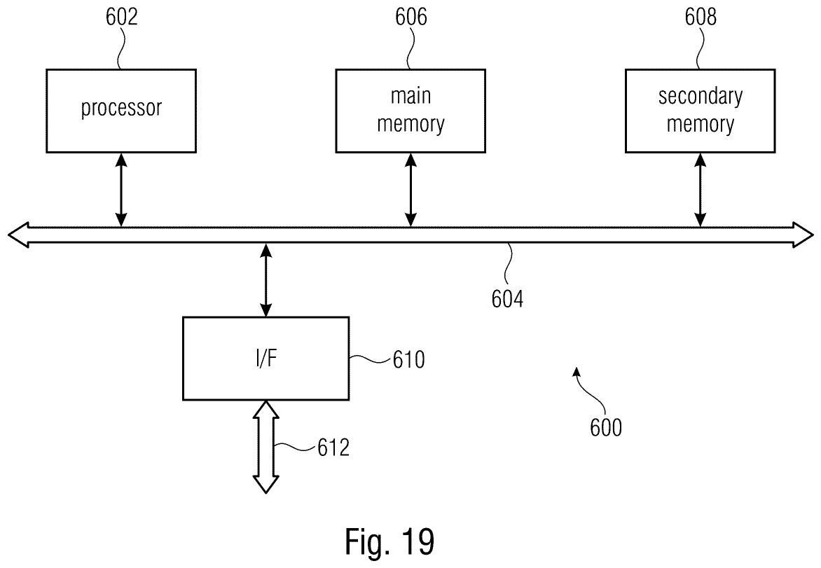

FIG. 19 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

In mobile communication systems or networks, like those described above with reference to FIG. 1, for example in a LTE or 5G/NR network, the respective entities may communicate directly with each other over a sidelink using one or more frequency bands in a high frequency range, like FR2. When operating in such a high frequency range, the respective entities communicating directly with each other over the sidelink may employ suitable techniques for focusing the wireless signal or the beam at the transmitting or receiving side in such a way that it is pointed towards the other communication partner, namely the receiving entity or the transmitting entity, either directly or via a reflector. Focusing the wireless signal or beam improves the transmission/reception of the radio signals and is achieved by employing two or more antennas at the respective entities generating a radiation pattern forming a beam directed in a predefined direction, which is also referred to in the following and in general as beamforming. The radiation pattern or beam may include one or more main lobes as well as one or more side lobes.

The radiation pattern for beamforming is typically formed by transmitting over more than one antenna element, whereas antenna elements may be located within an antenna panel, e.g., a single transmission/reception point, TRP, like a Tx/Rx Point, or may also be spread across multiple TRPs, e.g., using more than one antenna panel. The latter is also referred to as multi-TRP. A beam is formed by combining a set of antenna elements and transmitting the signal with a certain amplitude or power, and a certain phase or phase shift, simultaneously over these antenna elements. Simultaneously means that phase shifts have to be applied coherently, since impairments such as phase variations between signals transmitted over more than one antenna negatively impact the intended beam to be formed. Note that beamforming may be done fully digital, fully analog, or hybrid using both digital and analog components. This may also depend on the frequency band, where beamforming is done, e.g., high or low frequencies. Nevertheless, beamforming itself requires calibration of all involved hardware components, e.g., power amplifiers, antenna connectors, antennas etc. On top of beamforming, multiple data streams may be transmitted using precoding, yielding in a superposition of multiple beams for spatial multiplexing of several data streams. Nevertheless, for simplicity, this description refers to precoding also as a generalization of beamforming.

Furthermore, beamforming works in both transmit and/or receive direction. This means for example, that a very narrow beam may be formed and may be pointed to a certain destination or target receiver, thus that the energy at the receiver for this signal is maximized. In high frequencies, this results in very narrow beams, also referred to as pencil beams. The benefit is that a very narrow beam will not cause interference or only limited interference to other receivers which are in close vicinity of the intended receiver. At the receiver, receive beamforming may be used to point the receiver into the direction of the beam to be received, which may increase the quality of the received signal, e.g., in terms of SNR or SINR. Finally, the sharpness of a beam may be measured by the half power beam width, HPBW, which is an angular width in degrees, measure on the major lobe of an antenna radiation pattern at half power points. These are the points, e.g., left and right of the main lobe of a beam, at which the signal power is half of its peak value. In other words, the magnitude of the radiation pattern decreases by 3 dB when compared to the peak of the main beam in the effective radiated field. The smaller the angular width is, the “sharper” is the radiated beam. Note, that this effect also depends on the radiated frequency, since higher frequencies have a smaller wavelength resulting in a narrower and more directional beam.

Finally, using more than one antenna for transmissions may also be characterized as transmissions on spatial resources, which implies that data streams may be multiplexed not only in frequency and/or time domain, but also in the spatial domain as a new degree of freedom for increasing data rates and/or improving signal quality, e.g., increasing the SINR of a transmitted or received signal.

A frequency band includes a start frequency, an end frequency and all intermediate frequencies between the start and end frequencies. In other words, the start, end and intermediate frequencies may define a certain bandwidth, e.g., 20 MHz. A frequency band may also be referred to as a carrier or subcarrier, a bandwidth part, BWP, a subband, a subchannel, and the like.

When using a single frequency band, the communication may be referred to as a single-band operation, e.g., a UE transmits/receives radio signals to/from another network entity on frequencies being within the band, like the 20 MHz band.

When using a two or more frequency bands, the communication may be referred to as a multi-band operation or as a wideband operation or as a carrier aggregation operation. The frequency bands may have different bandwidths or the same bandwidth, like 20 MHz. For example, in case of frequency bands having the same bandwidths a UE may transmit/receive radio signals to/from another network entity on frequencies being within two or more of the 20 MHz bands so that the frequency range for the radio communication may be a multiple of 20 MHz. The two or more frequency bands may be continuous/adjacent frequency bands or some or all for the frequency bands may be separated in the frequency domain.

The multi-band operation may include frequency bands in the licensed spectrum, or frequency bands in the unlicensed spectrum, or frequency bands both in the licensed spectrum and in the unlicensed spectrum. For example, the unlicensed spectrum may include the 5 GHz band, the 6 GHz band, the 24 GHz band or the 60 GHz band. Examples of such unlicensed bands include the industrial, scientific and medical, ISM, radio bands reserved internationally for the use of radio frequency energy for industrial, scientific and medical purposes other than telecommunications.

Carrier aggregation, CA, is an example using two or more frequency bands in the licensed spectrum and/or in the unlicensed spectrum. Also mixed combinations are possible, e.g., one or more frequency bands in licensed and one or more frequency bands in unlicensed bands. Furthermore, CA may also be just used for aggregation of an additional carrier in one direction, e.g., as a supplemental carrier to improve transmissions via UL, DL or SL.

As mentioned above, wireless communication systems may include network entities, like base stations, supporting beam management of UEs including two or more antennas and forming a radiation pattern directing a radio signal in a certain direction, however, such beam management approaches are supported only for UEs which are connected to the base station via the Uu interface. Given the nature of the sidelink communication and of the involved entities, beam management as it is employed over the Uu interface may not be simply transferred and implemented on a sidelink. Nevertheless, introducing a high frequency operation, like a FR2 operation, for the sidelink requires enhancements of the existing approaches, like existing MIMO mechanisms, as well as an introduction of suitable beam management techniques on the sidelink so as to allow an efficient FR2 operation over the sidelink. For example, since the SL supports different operational modes, for example the above-mentioned Mode 1 and Mode 2, as well as different signaling techniques, which do not exist on the Uu link, beam management techniques and procedures for the SL, especially for a FR2 beam management, may differ substantially from what is needed for a beam management on the Uu interface. Therefore, it is not possible to simply transfer or implement the beam management approaches for the Uu interface to the SL. For example, additional SL features may be used for the beam management, like the sidelink feedback channel, PSFCH, or an inter-UE coordination technique, IUC, using sidelink assistance information messages, AIMs. Further, compared to the Uu interface, MIMO or beamforming on the SL may only support a limited antenna configuration. SL typically operates in the time division duplex, TDD, having the half-duplex constraint, meaning that a UE is not capable to receive while transmitting and vice versa. Another issue that makes SL beam management different to Uu beam management is that the antenna configurations on the SL are typically more symmetric, since similar compact antenna configurations are used by the involved UEs. On the other hand, in the Uu case the base station may benefit from a larger aperture or a higher number of antenna elements as well as more powerful transmit and receive power amplification circuits and the like. However, when a UE communicates with a roadside unit, RSU, via the SL, or in case a pedestrian UE, P-UE, or an IoT device, like VR-glasses or headsets, transmits data via the SL to a smartphone, the configuration may also be asymmetric.

FIG. 5 illustrates an example of a wireless communication system, similar to the one illustrated in FIG. 1, including the base station 250 serving, via the respective Uu interfaces a plurality of UEs 252₁ to 252₄, as is schematically illustrated by the arrows labeled Uu. Some or all of the UEs 252₁ to 252₄ may be capable of a sidelink communication, for example, using one or more resources as provided by the system in a sidelink resource pool. The UEs 252₁ to 252₄ operate in Mode 1, as is illustrated in FIG. 5, i.e., the sidelink communication may be assisted by the gNB 250 (see also FIG. 2(A) above). FIG. 5 further illustrates the UEs 254₁ to 254₃ which are not connected to the gNB 250 but operate in Mode 2, i.e., the sidelink communication is not assisted by the gNB 250 (see also FIG. 2(B) above). Among the UEs illustrated in FIG. 5, UEs 252₁, 252₃ and 254₁ to 254₃ include two or more antenna elements so as to allow generating a radiation pattern or beam 256 including at least one main lobe 256a and one or more side lobes 256b, thereby defining a main direction of a signal radiation by the UE. The radiation pattern, including the main and side lobes, is generated by applying appropriate pre-coders in the UE. This process is also referred to as beamforming. In the following, a sidelink transmission over the PC5 interface from the TX-UE 252₁ to the RX-UE 252₂ is considered. For the transmission, the TX-UE creates the radiation pattern or beam 256 such that it is directed towards the RX-UE. Thus, the TX-UE intends to communicate via the SL with the RX-UE, which are both operating in Mode 1 so as to benefit from control traffic or assistance from the base station 250 or from the network. In addition to TX-UE 252₁, also other UEs in the network, either operating in Mode 1 or in Mode 2, may perform transmissions using respective radiation patterns, each including at least one main lobe and one or more side lobes, as is illustrated, schematically, for UEs 252₃ and 254₁ to 254₃. These radiation patterns or beams (see the hatched main lobes in FIG. 5) may interfere with the communication between the TX-UE and the RX-UE. In other words, the communication link 260 between the TX-UE 252₁ and the RX-UE 252_{2′} may be inferred by the surrounding beams, namely the hatched beams created by UEs 252₃ and 254₁ to 254₃.

One may see that the beam 256 of the TX-UE generally points into the direction of the RX-UE, however, for an operation in FR2, a more precise alignment of the beam direction towards the RX-UE may be required. Conventionally, there are no techniques or approaches available for managing the beams 256 created by the respective UEs communicating over the sidelink for providing a reliable communication, for example in the high frequency range, and/or for handling interference situations as described above.

The present invention addresses the above needs by providing approaches allowing the management of one or more beams created at the respective sidelink entities when communicating over the sidelink, thereby allowing for an efficient and reliable operation of a sidelink communication in a high frequency band, like FR2. Stated differently, the present invention addresses the problems encountered in conventional approaches by providing various aspects enabling a beam management on the sidelink.

Embodiments of the present invention may be implemented in a wireless communication system as depicted in FIG. 1, FIG. 2(A) or FIG. 2(B) including base stations and users, like mobile terminals or IoT devices. FIG. 6 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 6, the one or more UEs 302, 304 of FIG. 6, and the base station 300 of FIG. 6 may operate in accordance with the inventive teachings described herein.

The present invention is advantageous over conventional approaches as by means of the subsequently described third aspects improvements of the beam management of user devices is achieved, which communicate over the sidelink using two or more antennas for generating directive radiation patterns, for example, by means of appropriately controlled pre-coders for directing or focusing a main lobe of the radiation pattern in a desired direction, which is also referred to as beamforming. Implementing sidelink specific beam management improves the communication between the sidelink UEs, especially in the high frequency range, like FR2, as the signal degradation which is experienced in this frequency band and also interferences from other UEs may be sufficiently suppressed or even avoided by an intelligent beam management. The present invention adapts some aspects known from conventional beam management approaches implemented via the Uu interface also for the sidelink and, in addition, provides sidelink specific beam management approaches yielding the above-mentioned advantages. When compared to conventional feedback mechanisms over the sidelink, the inventive approach allows for a more efficient and reliable SL communication, especially in higher frequency bands, as it allows for tighter controlling the beams to be used for the communication among the sidelink user devices.

### First Aspect

A first aspect of the present invention introduces a beam management report so as to allow for a network assisted beam management for the SL. For the beam management on the sidelink, the network may require additional knowledge about the configuration, reception and transmission characteristics as well as about the interference situation at one or more UEs. In accordance with embodiments of the first aspect, one or more UEs are allowed to generate a beam management report, BMR, and transmit the BMR via the Uu interface to the gNB or to another network entity, or also via the PC5 interface to another sidelink UE managing or assisting the beam management for of one or more other sidelink UEs. For example a group leader UE may receive the BMR for beam management purposes within its group. Furthermore, the BMR may also be relayed by a UE connected via Uu to a base station, e.g., in case a UE receives a BMR from another UE directly. In addition, this UE relaying the BMR may also merge BMRs from several UEs, to reduce signaling traffic to the base station or network. Finally, the BMR send to the network may also be modified by this said UE, e.g., it may reduce the BMR to select only certain sub-BMRs like a top-m statistic or it may select to only include BMRs of UEs which are within a certain destination of the base station or of itself, since BMRs from other locations might not be of interest for the base station or network.

UE providing BMR for SL UEs

The present invention provides a user device, UE, for a wireless communication network, the wireless communication network comprising a plurality of sidelink UEs, SL-UEs, communicating over a sidelink, SL, using more than one antenna or antenna element,
wherein the UE is to generate a beam management report, BMR, the BMR including information on one more beams in a radio environment at the UE,
wherein the UE is to provide the BMR for supporting beam management of one or more of the SL-UEs in the wireless communication network, directly or via a relay device, to
one or more network entities of the wireless communication network and/or
one or more further UEs of the wireless communication network.

In accordance with embodiments, for communicating over the SL, the SL-UE is to use more than one antenna or antenna element to form
a transmit, TX, beam, and/or
a receive, RX, beam.

In accordance with embodiments, the UE and/or the further UE comprises one of more of the following:
a SL-UE using more than one antenna or antenna element and operating as transmitting UE, TX UE, or receiving UE, RX UE, in Mode 1 and/or in Mode 2,
a UE using/not using more than one antenna or antenna element and communicating with a Radio Access Network, RAN, entity, like a gNB, an access point, AP, e.g., a WiFi AP, or a road side unit, RSU.

In accordance with embodiments, the network entity comprises one of more of the following:
a Radio Access Network, RAN, entity, like a gNB serving the UE, or a gNB not serving the UE, or a road side unit, RSU, or an access point, AP,
a Core Network, CN, entity, like a beam management network function, NF.

In accordance with embodiments, the UE is configured or pre-configured to monitor one or more beams or certain reference signals in the radio environment.

In accordance with embodiments, the UE is configured or pre-configured with a measurement window during which the UE monitors the one or more beams, the UE generating the BMR per measurement window or generating the BMR for a plurality of measurement windows.

In accordance with embodiments, the UE is configured with the measurement window via one or more of the following:
a resource pool, RP, configuration,
a physical layer, PHY, signaling, e.g.,
   a SCI, or
   a 1st-stage SCI including, e.g., a time resource indicator value, TRIV, and/or a frequency resource indicator value, FRIV of next reservation, or
   a 2nd-stage SCI, or
   a physical sidelink broadcast channel, PSBCH,
a Medium Access Control, MAC, layer, e.g., performing a MAC Control Element, MAC-CE signaling,
a Radio Resource Control, RRC, signaling,
higher layer signaling.

In accordance with embodiments, in a time domain, the measurement window is provided:
periodically, a periodicity depending on none or one or more of:
   a UE ID,
   a beam ID,
   a type of the UE, e.g., road side units, RSUs, may transmit, e.g., reference signals of the beam sweep, more often or less often in configured or pre-configured time slots,
   a certain formula taking one or more of the UE ID, the beam ID and the UE type into account, e.g., the periodicity may be randomized with the seed taken form the UE ID or the beam ID, or
aperiodically, e.g., trigger-based by a trigger that may be provided in a physical sidelink broadcast channel, PSBCH, or
during a DRX-window, wherein a particular UE is configured to transmit a beam training signal such that all other UEs a capable to perform a beam management and/or training.

In accordance with embodiments, in a frequency domain, the measurement window comprises one or more frequency resources, the frequency resources being selected:
depending on none or one or more of:
   a UE ID,
   a beam ID,
   a type of the UE, e.g., road side units, RSUs, may transmit more often or less often in configured or pre-configured frequency resources,
   a certain formula taking one or more of the UE ID, the beam ID and the UE type into account, or
responsive to a trigger, e.g., a frequency location based on an information from
   a further UE, e.g., via sidelink assistance information message, AIM, and/or via a physical sidelink broadcast channel, PSBCH, and/or
   the network, or
from a configured or pre-configured set of frequency resources, e.g., a special subband or carrier in which a particular UE is configured to transmit a beam training signal such that all other UEs are able to perform beam management and/or training.

In accordance with embodiments, monitoring the one more beams comprises performing measurements on one or more certain reference signals, e.g., a Demodulation Reference Signal, DMRS, a Sounding Reference Signal, SRS, a Primary Synchronization Signal, PSS, a Secondary Synchronization Signal, SSS, a Channel-State Information Reference Signals, CSI-RS, a specific beam beam-management reference signal, or a reference signal according to an artificial intelligent-machine learning, AI-ML, model.

In accordance with embodiments, the certain reference signal identifies, implicitly or explicitly,
the beam carrying the certain reference signal using, e.g., a beam identification, ID, and/or
a further UE from which the beam stems using, e.g., a UE ID.

In accordance with embodiments, the radio environment comprises
a set of configured or pre-configured resources, e.g., resources spanning an entire resource pool or a part of the resource pool, and/or
a physical channel for beam management, e.g., to carry the certain reference signals.

In accordance with embodiments, the BMR includes one or more of the following:
one or more beam IDs of one or more beams monitored by the UE,
an ID of the UE and/or of one or more UEs from which the one or more monitored beams stem and/or from the said UE,
a location of the UE and/or of one or more UEs from which the one or more monitored beams stem,
a distance from one or more UEs from which the one or more monitored beams stem,
a speed of the UE and/or of one or more UEs from which the one or more monitored beams stem,
a direction of movement or a motion vector or an angle of movement of the UE and/or of one or more UEs from which the one or more monitored radio beams stem
a type of the UE and/or of one or more UEs from which the one or more monitored beams stem, e.g., a Pedestrian UE, P-UE, a vehicular UE, a high-speed vehicle,
a signal strength of the one or more monitored beams, e.g., a Received Signal Strength Indication, RSSI, a Signal to Noise Ratio, SNR, a Signal to Interference plus Noise Ratio, SINR, a beam width,
an indication of m beams of all beams from one or more UEs, e.g., the top-m or the m first received beams, received from any UE, or from all UEs except one, or from a certain UE or from a group of UEs,
an indication of m beams of all monitored beams which cause the highest interference, e.g., the top-m or the m most interfering beams,
an interference map, the interference map containing, e.g., one or more of the following: when one or more interfering beams were received, on which antenna panel one or more interfering beams were received, or in which part of a frequency band, e.g., a subchannel, one or more interfering beams were received,
whether the UE and/or a UE form which the one or more monitored beams stem operates in Mode 1 or in Mode 2.

In accordance with embodiments, the UE is to provide the BMR using one or more of the following:
a physical layer, PHY, signaling, e.g., the BMR may be included in a SCI, or in a 1st-stage SCI, and/or in a 2nd-stage SCI, or in a physical sidelink broadcast channel, PSBCH,
a Radio Resource Control, RRC, signaling,
a Medium Access Control layer Control Element, MAC CE,
a higher layer signaling,
one or more sidelink assistance information messages, AIMs.

In accordance with embodiments, the AIM includes one or more of the following:
one or more preferred or non-preferred spatial resources to be used or not to be used during transmission,
an identity, ID, of the network entity or the further UE using the BMR for supporting beam management of one or more of the SL-UEs in the wireless communication network, e.g., a UE ID of a UE, like a group leader UE, GL-UE, or a scheduling UE, S-UE, which coordinates beams or performs beam management among one or more of the SL-UEs,
a beam collision indicator, which indicates that one or more certain beams were used within the same time window,
information for resolving an inter-beam interference which occur if two UEs use certain beams which interfere within the same time window.

In accordance with embodiments, the UE is to generate the BMR
periodically, wherein a periodicity of a periodical reporting may
   be configured or pre-configured, e.g., by a RAN or CN entity, by a UE requesting a BMR, by a special UE, e.g., a scheduling UE, S-UE, or a coordinating UE, or by a resource pool configuration, or
   depend on none or one or more of:
      a UE ID,
      a beam ID,
      a type of the UE, e.g., road side units, RSUs, may transmit more often or less often in configured or pre-configured time slots,
      a certain formula taking one or more of the UE ID, the beam ID and/or the UE type into account, e.g., the periodicity may be randomized with the seed taken form the UE ID or the beam ID, or
responsive to a trigger, e.g. a trigger provided or in a physical sidelink broadcast channel, PSBCH.

In accordance with embodiments, the generation of the BMR is triggered by one or more of the following conditions:
a report request from a UE or a gNB or a network entity of the CN, e.g., a network function, NF,
a change of one or more channel conditions exceeds a certain threshold, e.g., a rank of the channel, a power measured in a channel in terms of a Received Signal Strength Indication, RSSI, a Signal to Noise Ratio, SNR,
a detection of a new UE or a new beam ID,
an interference exceeding a certain threshold, e.g., a Signal to Interference plus Noise Ratio, SINR, threshold,
an expiry of a timer, e.g., loss of connectivity for a certain amount of time triggering a Radio Link Failure (RLF) recovery procedure,
a detection of a collision, e.g., due to a non-acknowledgement, NACK, received or due to a timeout,
a discovery or synchronization procedure, e.g., a UE receiving synchronization signal blocks, SSB,
a request in a physical sidelink broadcast channel, PSBCH.

### Network Entity Performing Beam Management for SL UEs Using the BMR

The present invention provides a network entity for a wireless communication network, the wireless communication network comprising a plurality of sidelink UEs, SL-UEs, communicating over a sidelink, SL, using more than one antenna or antenna element,
wherein the network entity is to receive, directly or via a relay device, a beam management report, BMR, from one or more UEs of the wireless communication network, the BMR including information on one more beams in a radio environment at the one or more UEs, and
wherein, using the BMR, the network entity is to perform or support or control beam management of one or more of the SL-UEs in the wireless communication network.

In accordance with embodiments, the network entity is to receive the BMR from one or more UEs according to the first aspect of the present invention.

In accordance with embodiments, the network entity comprises one or more of the following:
a SL-UE using more than one antenna or antenna element and operating as transmitting UE, TX UE, or receiving UE, RX UE, in Mode 1 or in Mode 2,
a UE using/not using more than one antenna or antenna element and communicating with a Radio Access Network, RAN, entity, like a gNB or a road side unit, RSU, or an access point, AP,
a Radio Access Network, RAN, entity, like a gNB serving the UE, or a gNB not serving the UE, or a RSU,
a Core Network, CN, entity, like a beam management network function, NF.

### Beamforming UE Providing Beam ID to be Included in BMR

The present invention provides a user device, UE, for a wireless communication network, the wireless communication network comprising a plurality of sidelink UEs, SL-UEs, communicating over a sidelink, SL, using more than one antenna or antenna element, and one or more further UEs according to the first aspect of the present invention,
wherein the UE is to communicate with a SL-UE and/or with a network entity of the wireless communication network using more than one antenna or antenna element, and
wherein the UE is to signal a beam identification of one or more of the beams formed by the UE, like a beam ID for each beam formed.

In accordance with embodiments, the beam is identified by one or more of:
a direct identification using, e.g., one or more of
   a beam ID,
   a sequence, e.g., beams may be identified depending on a configured or pre-configured sequence, e.g., a different code is used for each beam, e.g., using a code division multiplex access, CDMA, code or a special type of correlation sequence is used,
an indirect identification using, e.g., one or more of
   a time slot, e.g., relative time position in a sweep of beams,
   a frequency position, e.g., a frequency comb or a frequency pattern being different for different beams.

In accordance with embodiments, the UE is to include the beam identification into one or more of the following:
a discovery signal to be transmitted by the UE,
in case the UE operates in Mode 1, a scheduling request, SR, transmitted by the UE to a base station, optionally together with a UE ID of a target UE with which the UE intends to communicate.

### Methods

The present invention provides a method for operating a user device, UE, for a wireless communication network, the wireless communication network comprising a plurality of sidelink UEs, SL-UEs, communicating over a sidelink, SL, using more than one antenna or antenna element, the method comprising:
generating, by the UE, a beam management report, BMR, the BMR including information on one more beams in a radio environment at the UE, and
providing, by the UE, the BMR for supporting beam management of one or more of the SL-UEs in the wireless communication network, directly or via a relay device, to
one or more network entities of the wireless communication network and/or
one or more further UEs of the wireless communication network.

The present invention provides a method for operating a network entity for a wireless communication network, the wireless communication network comprising a plurality of sidelink UEs, SL-UEs, communicating over a sidelink, SL, using more than one antenna or antenna element, the method comprising:
receiving, by the network entity, directly or via a relay device a beam management report, BMR, from one or more UEs of the wireless communication network, the BMR including information on one more beams in a radio environment at the one or more UEs, and
performing or supporting or controlling, by the network entity, beam management of one or more of the SL-UEs in the wireless communication network, using the BMR.

The present invention provides a method for operating a user device, UE, for a wireless communication network, the wireless communication network comprising a plurality of sidelink UEs, SL-UEs, communicating over a sidelink, SL, using more than one antenna or antenna element, and one or more further UEs according to the first aspect of the present invention, the method comprising:
communicating, by the UE, with a SL-UE and/or with a network entity of the wireless communication network using more than one antenna or antenna element, and
signaling, by the UE, a beam identification of one or more of the beams formed by the UE, like a beam ID for each beam formed.

### Second Aspect

A second aspect of the present invention addresses beam management issues for sidelink UEs operating in Mode 2. More specifically a Mode 2 beam management without assistance of a base station is needed, which is more challenging since the beam management needs to be organized in a de-centralized way, i.e., without assistance of a base station or an RSU. Conventionally, no beam management for such scenarios is implemented, and embodiments of the second aspect address this issue by allowing a UE, which communicates with one or more further UEs using two or more antennas, to perform, what may be referred to as an opportunistic beam management by beam sweeping according to its time reference. In case the radio channel may be considered to be a reciprocal channel, also an interference may be estimated responsive to receiving beam sweeps from other UEs.

### Beam Sweeping

The present invention provides a user device, UE, for a wireless communication network,
wherein the UE is a sidelink UE, SL-UE, communicating with one or more further SL-UEs over a sidelink, SL, using more than one antenna or antenna element, the UE and the one or more further UEs performing beam management using beam sweeping,
wherein the UE is to perform the beam sweeping according to a configured or pre-configured beam sweep pattern.

In accordance with embodiments, the UE coordinates beam sweeping for one or more further UEs, for coordinating beam sweeping by the UE and the one or more further UEs, the UE is to
signal to the one or more further UEs its beam sweep pattern for allowing the one or more further UEs to adapt their beam sweep pattern, or
signal to one or more further UEs assistance information, indicating information to adapt or coordinate beams between UEs including one or more of
   collision indication, e.g., to trigger resource reselection,
   a preferred resource set, e.g., resources the other UE may use for its beam sweep pattern,
   one or more beam sweep patterns to use or to avoid,
   a non-preferred resource set, e.g., resources the other UE are to avoid to use for its beam sweep pattern,
   periodicity information, e.g., to indicate a preferred or non-preferred beam sweep periodicity or change of periodicity,
   one or more parameters to restrict or include into the beam sweep pattern, e.g., beam IDs, angle or sector of sweep, time and/or frequency and/or space of sweep, type of reference signal, and
receive from the one or more further UEs the respective beam sweep patterns and adapt its beam sweep pattern accordingly.

In accordance with embodiments, beam sweep pattern includes one or more of the following:
a sounding reference signal, SRS, e.g., a frequency comb,
a demodulation reference signal, DMRS,
a sidelink information, SCI, e.g.,
   a new type of SCI, or
   a 1^{st}-stage SCI including, e.g., a UE ID, or a periodicity of the beam sweep, or a time resource indicator value, TRIV, and/or a frequency resource indicator value, FRIV
   of next reservation, or a beam sweeping pattern, or one or more beam sweeping parameters, or a beam sweeping sequence, or
   2^{nd}-stage SCI
an assistance information message, AIM,
discovery information, e.g., a service type indicator indicating the UE to be, e.g., a relay, or a RSU, or a pedestrian UE, P-UE, or a vehicular UE.

In accordance with embodiments, the beam sweep pattern includes additional configuration information and/or a SCI and/or an AIM including one or more of:
a SCI with beam management fields,
a SCI with beam management field and without pointer to a 2nd stage SCI,
beam management fields including one or more of:
   a format of the beam management information,
   a beam pattern index, e.g., beams 3, 5 and 17,
   a precoding index,
   beam steering information, like:
      move beam left,
      move beam right,
   a power of a beam,
   a half power beam width of a beam, e.g., of the strongest beam,
   a periodicity of when next beam is coming,
   a length of a sweep, e.g., a complete sweep, like a 360° sweep, or a reduced sweep, like a 120° sweep,
   one or more target IDs, e.g., an intended receiver, so that the intended receiver may send a response to a given beam sweep, while UEs with other IDs do not respond to the transmitter,
   a type of the of beam sweep, like:
      a periodic sweep: this may include the periodicity of the beam sweep,
      an aperiodic sweep, e.g., a one-shot aperiodic beam sweep,
      a requested sweep, e.g., in response to a signaling from another UE.

### Methods

The present invention provides a method for operating a user device, UE, for a wireless communication network, the method comprising:
communicating, by the UE which is a sidelink UE, SL-UE, with one or more further SL-UEs over a sidelink, SL, using more than one antenna or antenna element, the UE and the one or more further UEs performing beam management using beam sweeping,
performing, by the UE, the beam sweeping according to a configured or pre-configured beam sweep pattern.

### Third Aspect—Beam Management Procedures

A third aspect of the present invention provides enhancements or improvements with regard to the operation of sidelink UEs communicating with each other using two or more antennas by providing sidelink specific beam management procedures which may be either network or network-side assisted or non-network assisted. In accordance with embodiments, a network assisted beam management may be performed by a RAN entity, like a base station, serving a plurality of UEs operating over the sidelink in a high frequency range, like FR2. The non-network-assisted beam management, on the other hand, includes procedures which are to be performed by the respective sidelink UEs operating, for example, in Mode 2.

### Network Assisted Beam Management

The present invention provides a user device, UE, for a wireless communication network,
wherein the UE is a sidelink, SL, UE, and is to communicate with one or more further SL-UEs over a sidelink, SL, using more than one antenna or antenna element,
wherein the UE is served by a base station of the wireless communication network, and
wherein the UE is to be assisted by the base station for one or more beam management procedures.

In accordance with embodiments, the UE is to be assisted by the base station in coordinating beam management in terms of one or more of:
beam pairing, e.g., to find beam pair links among the SL-UEs during discovery of neighboring SL-UEs within a required communication range,
beam maintenance,
beam failure recovery.

In accordance with embodiments, the UE is to be assisted by the base station in coordinating beam management during
SL discovery, and/or
SL link recovery, and/or
a data exchange over the SL so as to trigger a beam sweep at one or both of a transmitting SL-UE, TX SL-UE, and a receiving SL-UE, RX SL-UE.

In accordance with embodiments, the UE is a TX SL-UE or a RX SL-UE, and wherein, in case of a data exchange over the SL, the UE is to send to the base station a request for a beam sweep at one or more other SL-UEs, the request causing the base station to trigger a beam sweep at the one or more other SL-UEs, wherein the request may be included in a control signal or in a scheduling request, SR.

In accordance with embodiments, in case of a data exchange over the SL, the UE is to
receive a distribution of a beam sweep configuration to adjust transmissions over two or more transmit antennas of both the TX SL-UE and the RX SL-UE, wherein the beam sweep configuration may include a pre-coder configuration, timing, or frequency information, or
transmit assistance information, AIM, the AIM including beam coordination information, wherein the beam coordination information may include a pre-coder configuration, timing, or frequency information.

In accordance with embodiments,
the UE is to communicate with the further SL-UEs in a first frequency band, e.g., in one of a high frequency band, like FR2, and a low frequency band, like FR1, and
the UE is to be assisted by the base station in performing beam management procedures in a second frequency band, e.g., in the other one of the high frequency band, like FR2, and the low frequency band, like FR1.

The present invention provides a base station for a wireless communication network,
wherein the base station is to serve a plurality of sidelink UEs, SL-UEs, communicating with each other over a sidelink, SL, using beamforming, and
wherein the base station is to assist one or more of the SL-UEs in beam management procedures.

In accordance with embodiments, the base station is to assist in coordinating beam management in terms of one or more of:
beam pairing, e.g., to find beam pair links among the SL-UEs during discovery of neighboring SL-UEs within a required communication range,
beam maintenance, e.g., for keeping the beams aligned,
beam failure recovery.

In accordance with embodiments, the base station is to assist in coordinating beam management during
SL discovery, and/or
SL link recovery, and/or
a data exchange over the SL so as to trigger a beam sweep at one or both of a transmitting SL-UE, TX SL-UE, and a receiving SL-UE, RX SL-UE.

In accordance with embodiments, in case of a data exchange over the SL, the base station is to
receive from one of the SL-UEs a request for a beam sweep at one or more other SL-UEs, wherein the request may be included in a control signal or in a scheduling request, SR, and
responsive to the request, trigger a beam sweep at the one or more other SL-UEs, and wherein the request is signaled by a TX SL-UE or by a RX SL-UE.

In accordance with embodiments, in case of a data exchange over the SL, the base station is to cause
a distribution of a beam sweep configuration to adjust transmissions over multiple transmit antennas of both the TX SL-UE and the RX SL-UE, wherein the beam sweep configuration may include a pre-coder configuration, timing, or frequency information, or
a transmission of assistance information, AIM, among the TX SL-UE and the RX SL-UE, the AIM including beam coordination information, wherein the beam coordination information may include a pre-coder configuration, timing, or frequency information.

In accordance with embodiments,
the plurality of sidelink UEs, SL-UEs, communicate with each other over a sidelink, SL, using more than one antenna or antenna element in a first frequency band, e.g., in one of a high frequency band, like FR2, and a low frequency band, like FR1, and
the base station is to assist the one or more of the SL-UEs in performing beam management procedures in a second frequency band, e.g., in the other one of the high frequency band, like FR2, and the low frequency band, like FR1.

### Decentralized Beam Sweep

The present invention provides a user device, UE, for a wireless communication network,
wherein the UE is a sidelink, SL, UE, and is to communicate with one or more further SL-UEs over a sidelink, SL, using more than one antenna or antenna elements,
wherein the UE is to perform beam sweeping using a beam sweeping signal.

In accordance with embodiments, the UE is to transmit a communication request within the beam sweeping signal.

In accordance with embodiments, responsive to successfully receiving a communication response from a target SL-UE, the UE is to
determine matching beams of the UE and the target SL-UE, and/or
retain at least one beam pair link for a communication between the first SL-UE A and the second SL-UE.

The present invention provides a user device, UE, for a wireless communication network,
wherein the UE is a sidelink, SL, UE, and is to communicate with one or more further SL-UEs over a sidelink, SL, using more than one antenna or antenna elements,
wherein the UE is to receive from at least one of the further SL-UEs a beam sweeping signal.

In accordance with embodiments, the UE is to receive a communication request from the further SL-UE, the communication request being included within the beam sweeping signal.

In accordance with embodiments, responsive to successfully receiving the beam sweeping signal by the further SL-UE, the UE is to transmit a communication response including relevant information, the relevant information including one or more of:
a beam ID,
a UE ID, e.g., source and/or destination ID,
a type of UE, e.g., source and/or destination type, such as vehicular UE, RSU, P-UE,
a CSI feedback,
a type of sweeping signal, e.g., reference signals and/or beam pattern used,
UE capabilities, e.g., which features are supported such as maximum rank, peak data rate, supported codebooks,
a time slot of a matching beam, e.g., a time instance when a beam pair link may be established,
a frequency resource, e.g., a subchannel where a beam pair link may be established.

The present invention provides a wireless communication network, comprising:
a plurality of sidelink UEs, SL-UEs, communicating with each other over a sidelink, SL, using more than one antenna, e.g., using beamforming, the plurality of SL-UEs comprising a first SL-UE and a second SL-UE according to the third aspect of the present invention,
wherein the first SL-UE is to perform beam sweeping using a beam sweeping signal and transmit a communication request within the beam sweeping signal.

In accordance with embodiments, the first and second SL-UEs are synchronized with a time reference, and the first and second SL-UEs use the time reference for pointing to one or more time slots where beams transmitted by the first and second SL-UEs are matching.

In accordance with embodiments, the time reference is one of the following
an external time reference, e.g., GPS,
a network time reference, e.g., a time reference taken from a base station, a core network, CN, or from another server form the Internet,
a sidelink synchronization signal, SLSS,
a UE operating as a time reference, e.g., a transmitter UE being used as a time reference or for giving a relative time for the request sent by a UE.

### Beam Adjustments

The present invention provides a user device, UE, for a wireless communication network,
wherein the UE is a sidelink, SL, UE, and is to communicate with one or more further SL-UEs over a sidelink, SL, using more than one antenna or antenna elements,
wherein the UE is to communicate with at least one of the further SL-UEs over the sidelink, SL, using matching beams of the UE and the further SL-UE, and
wherein, responsive to a certain event, the UE is to perform a beam adjustment, e.g., such that a matching of the beam of the UE and the further SL-UE is maintained.

In accordance with embodiments, to perform the beam adjustment, the UE is to modify its beam from a first beam to a second beam, e.g., such that its beam is pointed into the direction of the further SL-UE, either directly or via a reflector.

In accordance with embodiments, the beam adjustment is performed responsive to one or more of the following events:
the further SL-UE moves from a first position at a first time instance to a second position at a second time instance,
the further SL-UE indicates a degradation, e.g., according to a power measurement of the beam,
the UE determines, responsive to a beam sweep or a reduced beam sweep testing neighboring side lobes of a main beam, a new main beam,
the further SL-UE reports a new beam having a higher power and/or less interference, e.g., a higher SINR or SNR or RSSI or a higher half-power beam width,
a change in a list indicating for a plurality of beams the m best beams (top-m list of beams) and/or the m worst beams (worst-m list of beams), e.g., in terms of signal power and/or interference,
the UE predicts a movement of the further SL-UE,
the UE predicts a better beam, e.g., to continue an angular shift of the beam,
receipt of assistance information, e.g., AIMs or higher layer assistance information, like a Cooperative Awareness Message, CAM, a Decentralized Environmental Notification Message (DENM) message comprising, e.g., one or more of: a velocity, a direction, an angle, a distance, a position, an acceleration, a future route, or a future position of the further SL-UE providing the assistance information.

In accordance with embodiments, the beam adjustment is to be performed based on
historic data, e.g., in case a beam was moved into a certain direction for a certain time unit, the beam is moved according to an interpolation into the certain direction, and/or
a data model produced, e.g., based on a configured or pre-configured data model or based on an artificial intelligence, AI, model and/or a machine learning, ML, model.

In accordance with embodiments, the data model is implemented
in the SL-UE, or
in another entity so as to be downloaded onto the SL-UE, the other entity comprising, e.g., a network entity, like a gNB or core network, CN, network function, NF, or another higher layer processor storing the data model, e.g., in the Internet.

The present invention provides a wireless communication network, comprising:
a plurality of sidelink UEs, SL-UEs, communicating with each other over a sidelink, SL, the plurality of SL-UEs comprising a first SL-UE according to the third aspect of the present invention and a second SL-UE communicating with each other over the SL using matching beams transmitted by the first and second SL-UEs, and
wherein, responsive to a certain event, one or both of the first and second SL-UEs are to perform a beam adjustment such that a matching of the beams transmitted by the first and second SL-UEs is maintained.

### Methods

The present invention provides a method for operating a user device, UE, for a wireless communication network, the method comprising:
communicating, by the UE which is a sidelink, SL, UE, SL-UE, being served by a base station of the wireless communication network, with one or more further SL-UEs over a sidelink, SL, using more than one antenna or antenna element, and
assisting the UE, by the base station, with one or more beam management procedures.

The present invention provides a method for operating a base station for a wireless communication network, the method comprising:
serving, by the base station, a plurality of sidelink UEs, SL-UEs, communicating with each other over a sidelink, SL, using beamforming, and
assisting, by the base station, one or more of the SL-UEs in beam management procedures.

The present invention provides a method for operating a user device, UE, for a wireless communication network, the method comprising:
communicating, by the UE which is a sidelink, SL, UE, SL-UE, with one or more further SL-UEs over a sidelink, SL, using more than one antenna or antenna element, and
performing, by the UE, a beam sweeping using a beam sweeping signal.

The present invention provides a method for operating a user device, UE, for a wireless communication network, the method comprising:
communicating, by the UE which is a sidelink, SL, UE, SL-UE, with one or more further SL-UEs over a sidelink, SL, using more than one antenna or antenna element, and
receiving, by the UE, from at least one of the further SL-UEs a beam sweeping signal.

The present invention provides a method for operating a user device, UE, for a wireless communication network, the method comprising:
communicating, by the UE which is a sidelink, SL, UE, SL-UE, with one or more further SL-UEs over a sidelink, SL, using more than one antenna or antenna element, wherein the UE communicates with at least one of the further SL-UEs over the sidelink, SL, using matching beams of the UE and the further SL-UE, and
responsive to a certain event, performing, by the UE a beam adjustment, e.g., such that a matching of the beam of the UE and the further SL-UE is maintained.

### General—Applies to all Above Aspects

In accordance with embodiments, the SL-UEs perform the SL communication in a high frequency band, e.g., in FR2, using resources from a licensed spectrum and/or from an unlicensed spectrum.

In accordance with embodiments, the SL-UEs perform the SL communication simultaneously using carrier aggregation (CA) or by using carrier switching utilizing
a high frequency band, e.g., in FR2, using resources from a licensed spectrum and/or from an unlicensed spectrum, and
a low frequency band, e.g., in FR1, using resources from a licensed spectrum and/or from an unlicensed spectrum.

In accordance with embodiments,
the UE comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a Wi-Fi device, station (STA), access point (AP), node or mesh node, or mesh point, or Mesh AP, or any sidelink capable network entity, and
the network entity of the wireless communication system comprises one or more of the following:
   a base station, like a macro cell base station, or a small cell base station, or a central unit of a base station, or a distributed unit of a base station, or an Integrated Access and Backhaul, IAB, node, or a Wi-Fi device such as an access point (AP) or mesh node (Mesh AP)
   a road side unit, RSU,
   a UE, like a SL UE, or a group leader UE, GL-UE, or a relay UE,
   a remote radio head,
   a core network entity, like an Access and Mobility Management Function, AMF, or a Service Management Function, SMF, or a mobile edge computing, MEC, entity,
   a network slice as in the NR or 5G core context,
   any transmission/reception point, TRP, enabling an item or a device to communicate using the wireless communication network, the item or device being provided with network connectivity to communicate using the wireless communication network,

### System—Applies to all Above Aspects

The present invention provides a wireless communication system, e.g., a 3^{rd} Generation Partnership Project, 3GPP, system or a WiFi communication system, comprising the user device, UE, and/or the network entity in accordance with the present invention.

### Computer Program Product—Applies to all Above Aspects

Embodiments of the present invention provide a computer program product comprising instructions which, when the program is executed by a computer, causes the computer to carry out one or more methods in accordance with the present invention.

Embodiments of the inventive aspect are now described in more detail with reference to the accompanying drawing. It is noted that the subsequently outlined and described aspects or embodiments may be combined such that some or all of the aspects/embodiments are implemented within one embodiment. Further, it is noted that when referring to “resources”, in this description, a resource is to be understood as comprising one or more of the following:
one or more symbols,
one or more time slots or subframes or frames,
one or more frequencies or carriers or subchannels or group of subchannels,
one or more interlaces,
one or more frequency bands, like unlicensed subbands,
one or more bandwidth parts,
one or more resource pools,
one or more LBT sub-bands,
one or more spatial resources, e.g., using spatial multiplexing, precoding and/or beamforming.

Furthermore, it is noted that when referring to “a set of resources”, in this description, a set of resources may contain one or more than one resource, with the definition of a resource as mentioned above. Moreover, it is noted that when referring to a “channel”, in this description, this may refer to a set of the resources as mentioned above. Thus, a “channel” may also refer to a single carrier, a sub-channel, a sub-band, a resource pool or a SL BWP.

### First Aspect

FIG. 7 illustrates embodiments of the first aspect of the present invention, more specifically FIG. 7(A) illustrates a UE 400 including a signal processing unit 402 and two or more antennas or one or more antenna arrays including two or more antenna elements 404. UE 400, for example, may be one of the UEs 252, 254 illustrated in FIG. 5. UE 400 is provided for a wireless communication network, like a 3^{rd} generation partnership project, 3GPP, network, which includes a plurality of sidelink UEs, like UEs 252 and 254 illustrated in FIG. 5, which communicate with each other directly over a sidelink using more than one antenna or antenna element. In accordance with embodiments of the first aspect of the present invention, UE 400 creates or generates a beam management report, BMR, as is illustrated at 406. The BMR includes information on one or more beams in a radio environment at the UE 400. For example, when considering FIG. 5 and assuming the UE 252₃, to operate according to the present invention, it may create the BMR on the basis of information about the beams transmitted by UEs 252 and 254 in FIG. 5, for example beams the UE is capable to recognize in its environment. Responsive to generating or creating the BMR, UE 400 may provide the BMR, e.g., by a direct communication as is indicated at 408, to one or more network entities of the wireless communication network and/or to one or more further UEs of the wireless communication network so as to allow the network entity or the further UE to use the BMR for supporting beam management of one or more of the sidelink UEs in the wireless communication network. For example, the BMR may be provided to the gNB 250 which, in turn, may support TX-UE 252₁ with the beam management for its communication with RX-UE 252₂. Additionally or alternatively, the beam management may be supported by another UE, like UE 254₁, and in that case, the UE may provide the BMR to UE 254₁ in FIG. 5.

In accordance with other embodiments, the BMR may also be relayed via a relay device to the one or more network entities and/or to the one or more further UEs. For example, the BMR may be relayed by a UE connected via Uu to a base station, e.g., in case a UE receives a BMR from another UE directly. In addition, this UE relaying the BMR may also merge BMRs from several UEs, to reduce signaling traffic to the base station or network. Finally, the BMR send to the network may also be modified by this said UE, e.g., it may reduce the BMR to select only certain sub-BMRs like a top-m statistic or it may select to only include BMRs of UEs which are within a certain destination of the base station or of itself, since BMRs from other locations might not be of interest for the base station or network.

Although it has been described that the beam management report is used for supporting beam management at the TX-UE which defines a transmit beam or radiation pattern using the two or more antennas, also referred as TX beamforming, the BMR may also be used for supporting beam management at the RX-UE 252₂ so as to direct a receiving beam towards the TX-UE, thereby reducing or avoiding interferences by other beams and/or providing a more reliable communication, i.e., receipt, of a signal from the TX-UE is ensured. In this case, the RX-UE forms, by means of the pre-coder and the two or more antennas, a receiving beam, which is also referred to as RX beamforming.

FIG. 7(B) illustrates a network entity for a wireless communication network according to further embodiments of the first aspect. The network entity 410 has a signal processing unit 412 and receives, as is indicated at 414, the BMR, which is provided, for example, by UE 400 described above with reference to FIG. 7(A). The network entity 410, on the basis of the received BMR, provides support of the beam management, BM, of one or more sidelink UEs in the network, as is indicated at 416, for example by sending appropriate control messages 420 towards the SL-UEs to be supported with regard to the beam management. In accordance with embodiments, the network entity may be one of the sidelink UEs, using the two or more antennas, providing a beam having a certain radiation pattern with a main lobe for transmitting or receiving data, i.e., the network entity 410 may, for example, be the TX-UE or the RX-UE in FIG. 5, when operating in Mode 1, or one of UEs 254₁ to 254₃ operating in Mode 2 as transmitting or receiving entity. In accordance with yet other embodiments, the network entity may be a UE, like UE 252₃ or 252₄ using or not using beamforming and communicating with the radio access network, RAN, entity, like the gNB 250 illustrated in FIG. 5 or with a roadside unit, RSU. In accordance with another embodiment, the network entity 410 may be a RAN entity, like a base station or gNB serving the UE providing the BMR, like gNB 250, or it may be a gNB not serving the UE providing the BMR, or it may be a roadside unit. In accordance with yet other embodiments, the network entity 410 may also be a core network, CN, entity connected to the gNB 250 in FIG. 5, which may include a beam management network function, NF.

Yet further embodiments of the first aspect of the present invention provide a user device, like any one of the user devices depicted in FIG. 5. FIG. 7(C) illustrates, schematically, a user device 420 having two or more antennas or an antenna array with two or more antenna elements 422 so as to allow forming a desired radiation pattern by using an appropriate pre-coder being directed into a desired direction. UE 420, as mentioned above, may be any of the UEs illustrated in FIG. 5, and the network of FIG. 5 also includes the sidelink UEs communicating with each other using two or more antennas for creating radiation patterns or beams 256 directed into a desired direction as well as one or more UEs according to UE 400 described above with reference to FIG. 7(A). UE 420 may perform a sidelink communication or a Uu communication with a sidelink UE and a network entity, respectively, i.e., for the communication the main lobe 424 of the radiation pattern or beam 426 is advantageously directed towards the communication partner which, as mentioned, may be a sidelink UE or a network entity. For allowing UE 400 to create or generate the BMR, UE 400 may monitor the beams in its radio environment, for example the beam 426 created by UE 420. To allow identifying the beams in the radio environment of UE 400, the surrounding UEs, like UE 420 signal a beam identification of a beam 424, for example a beam ID. In case more than one beam is formed by the antenna array or the plurality of antennas 422, each of the beams is identified, for example by an associated beam identification, beam ID. Furthermore, if more than one antenna panel is used, e.g., as in multi-TRP, a beam ID may also include a panel ID, such that an antenna panel may be identified. UE 420, for example, may be any one of the UEs 252 and 254 illustrated in FIG. 5, and in accordance with embodiments, each of the UEs performing beamforming for creating, using the two or more antennas, the radiation patterns or beams may be a UE according to FIG. 7(C) including a beam identification for the beams radiated so as to allow a UE 400 (see FIG. 7(A)) to generate the BMR by monitoring the beams in its environment and recognizing beams from the surrounding UEs on the basis of the beam identification.

As mentioned above, the beam identification may be a beam ID, however, in accordance with other embodiments, the beam may also be identified by a sequence, for example beams may be identified depending on a configured or pre-configured sequence meaning that a different code is used for each beam, for example using a specific code division multiplex access, CDMA, code or a special type of correlation sequence. Using the beam ID and the sequence allow for a direct identification of a beam, however, also an indirect identification is possible, for example by observing a time slot in which a beam is created or radiated, for example a relative time position in a sweep of beams. Also, in accordance with other embodiments, a frequency position may be used for indirectly identifying a beam of UE 420, for example by using different frequency combs or frequency patterns for different beams.

FIG. 8 illustrates the system of FIG. 5 in which, in accordance with the first aspect of the present invention, the beam management report is transmitted as is indicated at 408 by one or more UEs 400 (see FIG. 7(A)). The BMR is sent to the gNB 250 or to UE 254₁ which are the network entity 410 of FIG. 7(B). Any one of the UEs illustrated in FIG. 5 may be a UE in accordance with FIG. 7(C) signaling a beam indication of one or more beams.

As mentioned above, the report may be forwarded to the gNB 250 serving the UE providing the report, however, the BMR may also be forwarded to other network entities, for example other base stations. For example, when the beam management functionality is to be implemented across cell sites, the BMR is not only transmitted to a serving base station but may also be transmitted to the core network or to another base station or gNB, either through the core network or via a direct communication between the gNBs, using, for example, the XN interface. This may assist handover, HO, procedures. When the BMR is sent to the core network, a particular beam management network function, NF, within the core network may support the beam management at the respective sidelink UEs.

As mentioned above, the BMR may be sent from the TX-UE, RX-UE or any other UE which is connected via the Uu interface and may assist generating a meaningful BMR. The TX-UE may generate the BMR prior to its transmission so as to obtain from the gNB or network a beam management update for adjusting its one or more beams accordingly. Also, the RX-UE may generate a beam report to support the TX-UE with the beam selection/tuning for its transmission. In accordance with other embodiments, also another UE which is just monitoring the interference, like UE 252₃ in FIG. 5 or FIG. 8 may generate the BMR, for example on the basis of beams transmitted within its vicinity, and transmit the BMR to the gNB/network. Also, a sidelink UE, which operates in both, Mode 1 and Mode 2 may collect measurement reports from UEs which only operate in Mode 2 for generating and forwarding the BMR to the serving gNB/network, thereby improving beam management among UEs being under control of the gNB/network. In accordance with other embodiments, the BMR may also be received by a roadside unit, RSU, instead of a base station, for example in case of vehicular use cases.

Further embodiments of concerning the content of the BMR created or generated by UE 400 are now described. As mentioned above, the UE 400 may be one or more of the following:
a SL-UE using more than one antenna or antenna element and operating as transmitting UE, TX UE, or receiving UE, RX UE, in Mode 1 and/or in Mode 2,
a UE using/not using more than one antenna or antenna element and communicating with a Radio Access Network, RAN, entity, like a gNB, an access point, AP, like a WiFI AP, or a road side unit, RSU.

The network entity to which the BMR is sent, as is indicated at 408 in FIG. 7(A), may be one or more of the following:
a Radio Access Network, RAN, entity, like a gNB serving the UE, or a gNB not serving the UE, or a road side unit, RSU, or an access point, AP, like a WiFI AP,
a Core Network, CN, entity, like a beam management network function, NF.

As is illustrated in FIG. 7(A), for generating the BMR, the UE 400 is to monitor one or more beams or certain reference signals in its radio environment, as is schematically illustrated at 428 in FIG. 7(A). For creating or generating the BMR, UE 400 may be configured or pre-configured with a measurement or monitoring window during which the UE monitors one or more beams on a set of one or more resources which may span an entire resource pool or a part of the resource pool which is used for sidelink transmissions within the wireless communication network illustrated in FIGS. 5 and 7. The resource pool may also include the resources for both the Uu communication and the SL communication in the network of FIGS. 5 and 7. In accordance with further embodiments, the radio environment comprises a physical channel for beam management, e.g., to carry the certain reverence signals. The UE 400 may generate a BMR per measurement window or, in accordance with other embodiments, may generate the BMR on the basis of two or more measurement windows. In accordance with embodiments, the measurement window may be configured by one or more of the following:
a resource pool, RP; configuration,
   a physical layer, PHY, signaling, e.g., a SCI, or a 1^{st}-stage SCI including, e.g., a time resource indicator value, TRIV, and/or a frequency resource indicator value, FRIV of next reservation, or a 2^{nd}-stage SCI, or a physical sidelink broadcast channel, PSBCH,
a Medium Access Control layer, MAC, e.g., performing a MAC Control Element, MAC-CE, signaling,
a Radio Resource Control, RRC, signaling,
higher layer signaling.

A measurement window may be defined in the time domain and/or the frequency domain. In the time domain, the measurement window may be provided
periodically, a periodicity depending on none or one or more of:
   a UE ID,
   a beam ID,
   a type of the UE, e.g., road side units, RSUs, may transmit more often or less often in configured or pre-configured time slots, for example, beam sweeps or reference signals may be sent more often by a RSU than by a gNB,
   a certain formula taking one or more of the UE ID, the beam ID and/or the UE type into account, e.g., the periodicity may be randomized with the seed taken form the UE ID or the beam ID, or
aperiodically, e.g., trigger-based by a trigger that may be provided in a physical sidelink broadcast channel, PSBCH, or
during a DRX-window, wherein a particular UE is configured to transmit a beam training signal such that all other UEs a capable to perform a beam management and/or training.

In the frequency domain, the measurement window may include certain frequency resources which are selected:
depending on none or one or more of:
   a UE ID,
   a beam ID,
   a type of the UE, e.g., road side units, RSUs, may transmit more often or less often in configured or pre-configured frequency resources,
   a certain formula taking one or more of the UE ID, the beam ID and/or the UE type into account, or
responsive to a trigger, e.g., a frequency location based on an information from
   a further UE, e.g., via sidelink assistance information message, AIM, and/or via a physical sidelink broadcast channel, PSBCH, and/or
   the network, or
from a configured or pre-configured set of frequency resources, e.g., a special subband or carrier in which a particular UE is configured to transmit a beam training signal such that all other UEs are able to perform beam management and/or training.

In accordance with a further embodiment, the time/and/or frequency resources for the measurement window are derived from a formula. This has the advantage that a receiver interested in reference signals from a certain UE may derive them knowing some or all relevant parameters, such as beam ID, type of UE, beam IDs, . . . , thereby limiting the necessary search space to detect the signals. In accordance with another embodiment, a pseudo randomness may be applied to the function or formula thereby allowing for deterministic window positions avoiding constant collisions with another UE.

In accordance with embodiments, monitoring the one or more beams includes performing measurements on certain reference signals indicating implicitly or explicitly an associated beam, for example the beam ID as described above with reference to FIG. 7(C), and/or a UE from which the beam stems. The reference signals may include one or more of the following:
a Demodulation Reference Signal, DMRS,
a Sounding Reference Signal, SRS,
a Primary Synchronization Signal, PSS,
a Secondary Synchronization Signal, SSS,
a Channel-State Information Reference Signals, CSI-RS,
a specific beam beam-management reference signal,
a reference signal according to an artificial intelligent-machine learning, AI-ML, model, e.g., reference signals according to a configured or pre-configured AI-ML model, which is stored within the UE or the gNB or the network. The AI-ML model may be modified by another UE/gNB/network or even by the same UE according to a configured or pre-configured algorithm.

In accordance with embodiments, the BMR may include one or more of the following:
one or more beam IDs of one or more beams monitored by the UE,
an ID of the UE and/or of one or more UEs from which the one or more monitored beams stem and/or from the said UE,
a location of the UE and/or of one or more UEs from which the one or more monitored beams stem,
a distance from one or more UEs from which the one or more monitored beams stem,
a speed of the UE and/or of one or more UEs from which the one or more monitored beams stem,
a direction of movement or a motion vector or an angle of movement of the UE and/or of one or more UEs from which the one or more monitored radio beams stem
a type of the UE and/or of one or more UEs from which the one or more monitored beams stem, e.g., a Pedestrian UE, P-UE, a vehicular UE, a high-speed vehicle,
a signal strength of the one or more monitored beams, e.g., a Received Signal Strength Indication, RSSI, a Signal to Noise Ratio, SNR, a Signal to Interference plus Noise Ratio, SINR, a beam width,
an indication of m beams of all beams from one or more UEs, e.g., the top-m or the m first received beams received from any UE, or from all UEs except one, or from a certain UE, or from a group of UEs; e.g., the indication may be binary to indicate that there is no beam from a UE, i.e., no interference to be expected, or there is at least one beam, so that an interference is caused, or it may include a beam information delta or difference to a previous report, e.g., additional beams are detected when compared to a number in the previous report,
an indication of m beams of all monitored beams which cause the highest interference, e.g., the top-m or the m most interfering beams,
an interference map, the interference map containing, e.g., one or more of the following: when one or more interfering beams were received, on which antenna panel one or more interfering beams were received, or in which part of a frequency band, e.g., a subchannel, one or more interfering beams were received,
whether the UE and/or a UE form which the one or more monitored beams stem operates in Mode 1 or in Mode 2.

In accordance with embodiments, sending the BMR by UE 400 may be performed using one or more of the following:
a physical layer, PHY, signaling, e.g., the BMR may be included in a SCI, or in a 1^{st}-stage SCI, and/or in a 2^{nd}-stage SCI, or in a physical sidelink broadcast channel, PSBCH,
a Radio Resource Control, RRC, signaling,
a Medium Access Control layer Control Element, MAC CE,
a higher layer signaling,
one or more sidelink assistance information messages, AIMs.

In accordance with embodiments, the AIM may include one or more of the following:
one or more preferred or non-preferred spatial resources to be used or not to be used during transmission; e.g., the spatial resources may be defined by one or more of a MIMO mode, a number of antennas (TX and/or RX) used, a pre-coding technique used, or an applied beamforming technique,
an identity, ID, of the network entity or the further UE using the BMR for supporting beam management of one or more of the SL-UEs in the wireless communication network, e.g., a UE ID of a UE, like a group leader UE, GL-UE, or a scheduling UE, S-UE, which coordinates beams or performs beam management among one or more of the SL-UEs,
a beam collision indicator, which indicates that one or more certain beams were used within the same time window,
information for resolving an inter-beam interference which occur if two UEs use certain beams which interfere within the same time window; e.g., the information may include one or more of:
   time and/or frequency and/or space resources of interference,
   half power beam width of the one or more interfering beams,
   interference level, e.g., the signal strength of the interfering signal,
   UE IDs and/or beam IDs causing the interference,
   a direction of the interfering beam, e.g., a dominant path of the beam,
   preferred and/or non-preferred resources to use or avoid mitigating the interference,
   a precoder and/or codebook and/or antenna configuration.

Regarding the above-described non-preferred spatial resources, this may refer to certain resources a UE is not to use with its beam former, as it may cause an interference at a certain UE. Also, the non-preferred resource may indicate that other beams having side lobes causing interference in a certain direction are not to be used, i.e., certain side lobes that need to be suppressed to below a configured or pre-configured threshold so as to avoid or minimize beam interference to another receiving UE.

In accordance with further embodiments, the BMR may be created periodically or responsive to a trigger, e.g. a trigger provided or in a physical sidelink broadcast channel, PSBCH. For example, a periodicity of a periodical reporting may
be configured or pre-configured, e.g., by a RAN or CN entity, by a UE requesting a BMR, by a special UE, e.g., a scheduling UE, S-UE, or a coordinating UE, or by a resource pool configuration, or
depend on none or one or more of:
   a UE ID,
   a beam ID,
   a type of the UE, e.g., road side units, RSUs, may transmit more often or less often in configured or pre-configured time slots,
   a certain formula taking one or more of the UE ID, the beam ID and/or the UE type into account, e.g., the periodicity may be randomized with the seed taken form the UE ID or the beam ID.

The generation of the BMR may be triggered by one or more of the following conditions:
a report request from a UE or a gNB or a network entity of the CN, e.g., a network function, NF,
a change of one or more channel conditions exceeds a certain threshold, e.g., a rank of the channel, a power measured in a channel in terms of a Received Signal Strength Indication, RSSI, a Signal to Noise Ratio, SNR,
a detection of a new UE or a new beam ID,
an interference exceeding a certain threshold, e.g., a Signal to Interference plus Noise Ratio, SINR, threshold,
an expiry of a timer, e.g., a loss of connectivity for a certain amount of time triggering a Radio Link Failure, RLF, recovery procedure,
a detection of a collision, e.g., due to a non-acknowledgement, NACK, received or due to a timeout,
a discovery or synchronization procedure, e.g., a UE receiving synchronization signal blocks, SSB,
a request in a physical sidelink broadcast channel, PSBCH.

As described above with reference to FIG. 7(C), UE 420 provides an identification of its one or more beams. Thus, in accordance with embodiments, in addition to the content and timing aspects of the BMR, by means of UE 420, certain procedures are adapted in the network so as to provide beam information for putting it into the BMR, like the beam ID which, for example, is not specified within the conventional SCI report for the sidelink. Therefore, in accordance with embodiments, by means of UEs 420 beam IDs are exchanged such that UE 400 is in a position to monitor the beam IDs. In accordance with embodiments, the beam is identified directly or indirectly. A direct identification may use, e.g., one or more of a beam ID, or a sequence, e.g., beams may be identified depending on a configured or pre-configured sequence, e.g., a different code is used for each beam, e.g., using a code division multiplex access, CDMA, code or a special type of correlation sequence is used. An indirect identification may use, e.g., one or more of a time slot, e.g., relative time position in a sweep of beams, or a frequency position, e.g., a frequency comb or a frequency pattern being different for different beams. In accordance with embodiments, the UE may include the beam identification into a discovery signal to be transmitted by the UE, and/or, in case the UE operates in Mode 1, into a scheduling request, SR, transmitted by the UE to a base station, optionally together with a UE ID of a target UE with which the UE intends to communicate. Providing, in addition to the beam ID also a UE ID of a target US with which a communication is intended, is advantageous as it allows, for example, a gNB, like gNB 250 in FIGS. 5 and 7, to assist in the coordination of the beams among the communicating sidelink UEs.

### Second Aspect

FIG. 9 illustrates an embodiment of a user device, UE, 430 for a wireless communication network in accordance with the second aspect of the present invention. UE 430 is a sidelink UE which communicates with one or more further UEs over a sidelink. The sidelink UE 430 includes a signal processing unit 432 and two or more antennas or one or more antenna arrays having at least two antenna elements 434 so as to allow the UE 430 to communicate with the other UEs over the sidelink using a radiation pattern or beam 436 which is formed, using appropriate pre-coders, to be directed into a certain direction. In accordance with embodiments of the second aspect of the present invention, UE 430 is configured or pre-configured with a beam sweep pattern 438 which is processed by the signal processing unit 432 so as to cause a beam sweep of the beam 436, as is illustrated by the arrows 436a and 436b sweeping the beam 436 for example, from the upper beam direction 436′ to the lower beam direction 436″.

In accordance with embodiments, UE 430 is to coordinate its beam sweeping operation with one or more further UEs so as to reduce the sensing effort. For example, in case all UEs are performing beam sweeping simultaneously, since the UEs are not operating in a full-duplex mode, the UEs are not capable to receive the beams and, therefore, calculating the required beam ID which leads to the best reception is not possible. Thus, beam sweeps have to be coordinated among the UEs. For example, UE 430 may signal to the one or more further UEs its beam sweep pattern or assistance information for allowing the one or more further UEs to adapt the beam sweep pattern accordingly to avoid simultaneous beam sweeping. The assistance information may indicate information to adapt or coordinate beams between UEs including one or more of:
collision indication, e.g., to trigger resource reselection,
a preferred resource set, e.g., resources the other UE may use for its beam sweep pattern,
one or more beam sweep patterns to use or to avoid,
a non-preferred resource set, e.g., resources the other UE are to avoid to use for its beam sweep pattern,
periodicity information, e.g., to indicate a preferred or non-preferred beam sweep periodicity or change of periodicity,
one or more parameters to restrict or include into the beam sweep pattern, e.g., beam IDs, angle or sector of sweep, time and/or frequency and/or space of sweep, type of reference signal.

In addition or alternatively, the UE 430 may receive the beam sweep patterns from one or more of the further UEs for adapting its beam sweep pattern accordingly. The beam sweeps may be coordinated using, for example, control messages, like a SCI, or they may be timed for defining a certain beam sweep pattern. The beam sweep pattern may have some periodicity, and it may be configured to operate aperiodically or periodically. However, in case two UEs are configured with the same beam sweeping pattern, they are not able to receive each other's beam training signals and in that case, assistance information, like AIMs, may be used for coordinating beam sweeping such that one of the UEs, for example, shifts its beam sweeping pattern accordingly.

In accordance with embodiments, the beam sweeping pattern may include one or more of the following:
A sounding reference signal, SRS, e.g., a frequency comb.
A demodulation reference signal, DMRS.
A sidelink information, SCI, e.g.,
   a new type of SCI, or
   a 1^{st}-stage SCI including, e.g., a UE ID, or a periodicity of the beam sweep, or a time resource indicator value, TRIV, and/or a frequency resource indicator value, FRIV of next reservation, or a beam sweeping pattern, or one or more beam sweeping parameters, or a beam sweeping sequence, or
   a 2^{nd}-stage SCI.
An assistance information message, AIM.
Discovery information, e.g., a service type indicator indicating the UE to be, e.g., a relay, or a RSU, or a pedestrian UE, P-UE, or a vehicular UE.

The beam sweep pattern may include additional configuration information and/or a SCI and/or an AIM including one or more of:
A SCI with beam management fields.
A SCI with beam management field and without pointer to a 2^{nd} stage SCI.
Beam management fields including one or more of:
   A format of the beam management information.
   A beam pattern index, e.g., beams 3, 5 and 17.
   A precoding index.
   Beam steering information, like:
      move beam left,
      move beam right.
   A power of a beam.
   A half power beam width of a beam, e.g., of the strongest beam. The half Power Beam Width or HPBW is an angular width (in degrees), measured on the major lobe of an antenna radiation pattern at half-power points, i.e., the points at which the signal power is half that of its peak value. In other words, The Half Power Beamwidth (HPBW) is the angular separation in which the magnitude of the radiation pattern decreases by 50% (or −3 dB) from the peak of the main beam or lobe.
   A periodicity of when next beam is coming.
   A length of a sweep, e.g., a complete sweep, like a 360° sweep, or a reduced sweep, like a 120° sweep.
   One or more target IDs, e.g., an intended receiver, so that the intended receiver may send a response to a given beam sweep, while UEs with other IDs do not respond to the transmitter. For example, a target ID may also be a broadcast ID or a groupcast ID, e.g., a certain group is addressed by a beam sweep. The group may also comprise of a certain set of devices, e.g., P-UEs only, or IoT devices only, or certain messages, e.g., UEs which have to transmit emergency messages only send a response.
   A type of the of beam sweep, like:
      a periodic sweep: this may include the periodicity of the beam sweep,
      an aperiodic sweep, e.g., a one-shot aperiodic beam sweep,
      a requested sweep, e.g., in response to a signaling from another UE.

FIG. 9, also illustrates the beam sweeping coordination with another UE 440. Like UE 430, also UE 440 has a signal processing unit 442 and two or more antennas or one or more antenna arrays including at least two antenna elements 444 allowing UE 440 to generate a radiation pattern or beam 446. Also, by means of the signal processing unit 442, UE 440 implements a certain beam sweep pattern for sweeping the beam 446 as illustrated at 446a and 446b so that the beam is swept between, for example, a position at 446′ and a position at 446″. UEs 430 and 440 may exchange control signaling, as is schematically indicated at 448 which may be a sidelink connection. UE 430 and UE 440 may coordinate, via the connection 448 the beam sweeping pattern in such a way that they do not simultaneously perform a beam sweep. For example, if the beam sweeping pattern indicates that both UEs perform the beam sweep during overlapping times, one of the UEs may postpone or shift the start of the beam sweeping operation responsive to becoming aware of the beam sweeping pattern of the other UE.

In accordance with further embodiments, for example, in a situation in which the RAN does not provide assistance for scheduling or the like but nevertheless the UEs have a Uu connection to the base station, the connection 448 may also be via the base station.

### Third Aspect

### Network Assisted Beam Management

Embodiments of the third aspect are now described in more detail, and FIG. 10 illustrates an embodiment in accordance with which network or network-side assisted beam management procedures are implemented, e.g., gNB-assisted beam management procedures. FIG. 10 illustrates a UE 500 in accordance with embodiments of the third aspect, which comprises a signal processing unit 502 and two or more antennas or one or more antenna arrays with at least two antenna elements 504 allowing the signal processing unit 502, which may include a pre-coder and the like, to form a desired radiation pattern or 506. FIG. 10 illustrates a further sidelink UE 510 also including a signal processing unit 512 and two or more antennas or one or more antenna arrays including at least two antenna elements 514 so as to allow the signal processing unit 512 to generate 4 a desired radiation pattern or beam 516. UE 500 may communicate over the sidelink or PC5 interface directly with UE 510. Both UEs 500, 510 operate in Mode 1, i.e., they are connected via the Uu interface to a base station 520. The base station 520 includes a signal processing unit 522 and one or more antennas or at least one antenna array including one or more antenna elements 524 for setting up the radio link with the UEs 500, 510 via the Uu interface. The base station 520, by means of the signal processing unit 522 implements a beam management function. UEs 500 and 510 receive, via the Uu interface, control signaling from the base station, more specifically, control signal originating from the beam management function implemented in the base station 520, and on the basis of the control signals received from the base station, a gNB-assisted beam management may be performed at UE 500 and/or at UE 510.

Thus, in accordance with embodiments of the third aspect, a user device for a wireless communication network, like a third generation partnership project, 3GPP, network, is provided, like UE 500, which is a sidelink UE communicating with another sidelink UE, like UE 510, over the sidelink using two or more antennas 504, wherein the UE 500 is to receive from a base station, with which it may be connected via the Uu interface, a control signaling on the basis of which the beam management at the UE 500 is performed. As mentioned above, this may be referred to as a network assisted or, in the depicted embodiment, a gNB-assisted beam management procedure. Further embodiments of the third aspect concerning the network-assisted beam management provide a base station, like the base station 520, serving a plurality of sidelink UEs, like UE 500 and UE 510 which communicate over the sidelink with each other using two or more antennas, also referred to as a communication using beamforming, and the base station assists one or more of the sidelink UEs 500, 510 in the beam management procedures to be performed at the sidelink UE.

In accordance with embodiments, the base station may assist the one or more sidelink UEs 500, 510 in coordinating the beam management, for example, in terms of beam pairing, beam maintenance, or beam failure recovery. Beam pairing may include the finding of beam pair links among the sidelink UEs 500, 510 during discovery of neighboring sidelink UEs which are within a predefined or required communication range. For example, the base station may initiate, as one beam management procedure, at one of the UEs 500, 510 a beam sweeping operation to determine a direction from which a signal from a communication partner for the sidelink communication is received, for example, with a required signal strength indicating that the UE is within the required communication range. The beam maintenance procedure may keep the beams aligned, e.g., by adjusting the beam directions in case one of the UEs 500, 510 or both of the UEs move relative to each other so that the directions of the beams 506, 516 need to be adjusted so as to be focused or directed to each other. Beam failure recovery may be needed in case an initially found or existing beam pair link is no longer available or sufficient for maintaining the communication between UE 500 and UE 510, for example, due to interferences on the link by newly added UEs in the environment or due to a degradation of the channel conditions. In such a case, the link may fail and responsive to detecting such a link failure, the beam failure recovery may be started via the base station 520 at the respective UEs 500, 510.

In accordance with embodiments, base station 520 may assist a UE, like UE 500 and/or UE 510 during a sidelink discovery procedure, i.e., in a procedure by which the UE 500, for example, discovers one or more further UEs, like UE 510, which are in the surroundings of the UE so that a direct communication among the UEs is possible. In addition or alternatively, the gNB-assisted beam management may also be carried out during a SL link recovery, i.e., in a procedure by which the UE 500, for example, recovers a link with one or more further UEs, like UE 510 following, e.g., a radio link failure.. In addition or alternatively, the gNB-assisted beam management may also be carried out during a data exchange over the sidelink, i.e., following the sidelink discovery procedure. For example, in case UE 500 has a data transmission to be performed over the sidelink to a receiving UE, like UE 510, the base station, responsive to a signaling over the Uu interface concerning the intended transmission, may trigger at both UEs 500, 510, a beam management operation, like a beam sweep, for finding a beam pair link to be used for the transmission of the data from UE 500 to UE 510 over the sidelink.

FIG. 11 illustrates an embodiment for a beam sweep trigger to be performed during sidelink discovery or data exchange. FIG. 11 illustrates UE 500, UE 510 and the base station or gNB 520. UEs 500, 510 operate in Mode 1 and are connected to the base station 520 via the Uu interface. By means of their antennas, desired radiation patterns or beams 506, 516 are formed. During the sidelink discovery or during a data exchange, base station 520 may trigger a beam sweep at the TX-UE 510 and/or at the RX-UE 510, as is indicated by the beam sweep trigger signals 530a and 530b.

In accordance with another embodiment, a beam sweep may be initiated or triggered by a UE which has a communication request. FIG. 12(A) illustrates a setup similar to the one of FIG. 11, however, other than in FIG. 11, it is assumed that the TX-UE 500 has data to be exchanged with RX-UE 510 and sends, via the Uu interface, a communication request 532 to the gNB. The communication request 532 may be included into a specific control signal sent from the TX-UE 500 to the gNB 520 or it may be included in a scheduling request, SR, sent by UE 500 to gNB 520 for scheduling the sidelink resources to be used for the sidelink communication between UE 500 and 510. Responsive to receiving the communication request 532, gNB 520 triggers the beam sweep, as indicated at 534 at the RX-UE 510, namely at the UE which, according to the communication request, is the communication partner of TX-UE 500. It is noted that the just-described embodiment is not limited to initiating or triggering the beam sweep by the transmitting UE, rather, in accordance with other embodiments, the trigger may also stem from the receiving UE. For example, as is illustrated in FIG. 12(B), the transmitting UE 500 may inform the receiving UE 510, for example, via a SCI, about an upcoming transmission, and responsive to this information, the receiving UE which, for example, may determine that the direction from which the SCI was received needs to be improved may send a communication request or a similar control signal 532 to the gNB 520 which then triggers 534 the beam sweep operation at the TX-UE 500 so as to focus or direct the beam 506 better towards the receiving UE 510. Note, that this approach is not limited to unicast, but that a UE ID may also be a groupcast ID, and the gNB may also trigger a certain group of UEs to perform beam sweeping. Furthermore, a gNB may also restrict its trigger to perform a beam sweep to a certain UE within a group, so that other UEs within the same group may receive a beam sweep and are refrained from performing beam sweeps themselves. In this way, it may be guaranteed that all group members may receive the beam sweep and do not miss the beam information due to the half-duplex constraint. Thus, the communication request and/or the beam sweep trigger may also in addition or as an alternative contain a group ID or a groupcast trigger.

In accordance with further embodiments, the gNB 520 may distribute a beam sweep configuration among the UEs. FIG. 13 illustrates a situation similar to FIG. 12(B) in which the receiving UE 510 initiated the beam sweep at the transmitting UE 530, via the gNB 520. In accordance with embodiments, the base station 520 signals to the RX-UE 510, responsive to the communication request 532, the beam sweep configuration applied at TX-UE 500, as is indicated at 536. It is noted that the additional information may also be provided in the embodiment of FIG. 12(A) in which the TX-UE triggered the beam sweeping operation at the RX-UE 510 via the gNB. In such a scenario, the gNB 520 distributes the beam sweep information 536 back to the transmitting UE 500.

In accordance with further embodiments, responsive to receiving the beam sweep trigger 534 rather than providing the beam sweep information 536 via the gNB, the UE that received the beam sweep trigger 534, like UE 500 in FIG. 13, may transmit the beam sweep information over the sidelink, using for example a sidelink assistance information message SL-AIM, as is schematically indicated in FIG. 13 at 538. The AIM may include beam coordination information, for example, information about a pre-coder configuration, timing of frequency information. Thus, by providing the UE, which triggered the beam sweep via the gNB or via the SL, with the additional beam sweep configuration, this UE is aware of the specifics of the beam sweep to be carried out by its communication partner, thereby improving the beam management process.

In accordance with the embodiments described so far, the beam management functions are implemented in the frequency range in which the sidelink communication takes place, like FR2. However, in accordance with further embodiments, the sidelink communication and the beam management may be performed in different frequency bands. For example, in case the sidelink UEs are capable of utilizing different frequency bands, for example, a frequency band in FR1 and a frequency band in FR2, the actual beam management for the sidelink may be performed using a frequency band where both UEs have a stable connection, for example, in a lower frequency band in FR1. FIG. 14 illustrates an embodiment in which the transmitting UE 500 and the receiving UE 510 are capable to operate in FR1 and in FR2. For the sidelink communication, FR2 is used while for the beam management a signaling via FR1 is used. As is indicated in FIG. 14, the beam sweep triggers 530a, 530b (see also FIG. 11) are provided by the base station 520 in FR1 thereby allowing the UEs to perform the beam management for the high frequency band via the low frequency band, for example, via carrier aggregation or carrier switching such that both UEs switch to the high frequency band once the beam pair link is established. It is noted that the beam management in the low frequency band is not limited to the scenario in FIG. 14, also the scenarios described above with reference to FIGS. 12 and 13 may implement the beam management in the lower frequency band, for example, in FR1. Note that in this scenario, the UEs operating in FR2 may be Mode 2 UEs, while the configuration in FR1 may be either without the assistance of a base station, e.g., in Mode 2, or with assistance of a base station, e.g., in Mode 1. Finally, instead of using a different frequency band for management, also a different radio access technology, RAT, may be used for managing the beam management, e.g., LTE or WiFi.

It is noted that, in accordance with yet further embodiments, the UEs may communicate with the further SL-UEs in a first frequency band, e.g., a low frequency band, like FR1, and are assisted by the base station in performing beam management procedures in a second frequency band, e.g., a high frequency band, like FR2.

### Non-Network Assisted Beam Management

In accordance with other embodiments of the third aspect of the present invention, a non-network assisted beam management may be implemented, which is also referred to as a decentralized beam management. Such embodiments may apply for situations in which the respective sidelink UEs operate without assistance from the network so that the beam management needs to be performed decentralized. FIG. 15 illustrates an embodiment of a UE 550 including a signal processing unit 552 and two or more antennas or at least one antenna array including two or more antenna elements 554 for creating a desired radiation pattern or beam 556 for a sidelink communication, for example via the PC5 interface, with another sidelink UE. For performing a decentralized beam management, UE 550 performs beam sweeping as is illustrated by the arrows 556a and 556b. In accordance with embodiments, the UE 550 may include into the beam sweeping signal a communication request. UE 550 may receive from the communication partner a communication response including relevant information for the connection, for example one or more of:
a beam ID,
a UE ID, e.g., a source and/or destination ID,
a type of UE, e.g., a source and/or destination type, such as vehicular UE, RSU, P-UE,
a CSI feedback,
a type of sweeping signal, e.g., reference signals and/or beam pattern used,
UE capabilities, e.g., which features are supported such as maximum rank, peak data rate, supported codebooks,
a time slot of a matching beam, e.g., a time instance when a beam pair link may be established, and/or a frequency resource, e.g., a subchannel where a beam pair link may be established.

On the basis of the received information included in the communication response, UE 550 may determine whether there are matching beams between the UE 550 and its communication partner so that at least one beam pair link for a communication over the sidelink may be retained.

Further embodiments of the third aspect of the present invention concerning the decentralized management procedure pertain a user device 560, which is the communication partner of UE 550 in FIG. 15 and which also includes a signal processing unit and two or more antennas or at least one antenna array with at least two antenna elements 564 for creating a radiation pattern or beam 566. UE 560 receives from UE 550 the beam sweeping signal 556. In accordance with embodiments, the UE 560 may also receive a communication request included in the beam sweeping signal 556 of UE 550. Responsive to successfully receiving the beam sweeping signal, UE 560 transmits the above-mentioned communication response including the relevant information so as to allow UE 550 to determine matching beams transmitted by the UEs 550, 560 to be retained for a communication over the sidelink between these UEs.

Thus, the beam management among UEs operating without assistance of the network is performed decentralized and, as is depicted in FIG. 16, in accordance with embodiments, a transmitting UE 550 performs beam sweeping and transmits the communication request 570 within the beam sweeping signal 556. The communication request, for example, includes information about the beam sweep, a synchronization signal and a discovery signal. For example, an ID of UE 550, a beam ID or panel ID, a message type and an application type may be included in the communication request 570. In case the receiving UE 560 successfully decodes the beam sweeping signal via a receiving beam 566, for example at the time the beam is at position 556″, the above-mentioned communication response is transmitted as indicated at 572 which may include the information on the beam sweep, the synchronization signal, the discovery signal, a data transmission or any other of the above mentioned relevant information. The transmission may be performed based on timing information included in the signaling by UE 550 such that UE 550 receives the communication response and the included information so as to be in a position to retain the successful beam pair link formed by beam 556″ at UE 550 and beam 566 at UE 560. This successful beam pair link is then used for the communication between the UEs 550 and 560 via the sidelink.

In accordance with further embodiments, the UEs 550 and 560 may be synchronized using an external time reference. In such a scenario, beam IDs are not necessary and may be neglected since the UEs may use the time reference to point to time slots where the beams 556 and 566, which are transmitted by UE 550 and UE 560, match. The above-mentioned time reference may include one or more of the following:
an external time reference, e.g., GPS,
a network time reference, e.g., a time reference taken from a base station, a core network, CN, or from another server form the Internet,
a sidelink synchronization signal, SLSS,
a UE operating as a time reference, e.g., a transmitter UE being used as a time reference or for giving a relative time for the request sent by a UE.

Further embodiments of the third aspect of the present invention concerning the decentralized beam management are now described, namely embodiments which, other than the previously described embodiments concerning beam sweeping, refer to a beam adjustment by one of the sidelink UEs responsive to a certain event. FIG. 17 illustrates a UE 570 in accordance with an embodiment of the third aspect of the present invention including a signal processing unit 572 and two or more antennas or at least one antenna array including two or more antenna elements 574 for generating a desired beam pattern or beam 576. It is assumed that UE 570 established a communication link with a further sidelink UE over the PC5 interface using, for example, the radiation pattern or beam 576 so that the beam is directed towards the communication partner. Responsive to a certain event, UE 570 may perform a beam adjustment, for example by adjusting the radiation pattern or beam such that the main radiation direction is moved from the direction as indicated at 576 to the direction as indicated at 576′. FIG. 17 further illustrates, schematically, a wireless communication network including UE 570 and a further SL-UE 580. UE 580, like UE 570, includes a signal processing unit 582 and two or more antennas or at least one antenna array having at least two antenna elements 584 for creating a desired radiation pattern or beam 586 directed into a certain direction. The sidelink connection between UEs 570 and 580 via the PC5 interface is also illustrated. In accordance with embodiments either one of UEs 570 and 580 or both of them may initiate a beam adjustment of beams 566 and/or 586 to point into the direction 566′ and/or 586′ in case either one of the UEs or both of them recognize a certain event requiring the beam adjustment.

In accordance with embodiments, as also depicted in FIG. 17, the beam adjustment may include a modification of the UE's radiation pattern such that the beam is modified from a first beam, like beam 566 or 586, to a second beam 566′ or 586′ so that the respective UEs 570, 580 provide radiation patterns or beams pointing to each other either directly or via a reflector 590. In accordance with embodiments, a UE may perform the beam adjustment responsive to one or more of the following events:
UE 580 moves from a first position at a first time instance to a second position at a second time instance,
UE 580 indicates a degradation, e.g., according to a power measurement of the beam,
UE 570 determines, responsive to a beam sweep or a reduced beam sweep testing neighboring side lobes of a main beam, a new main beam,
UE 580 reports a new beam having a higher power and/or less interference, e.g., a higher SINR or SNR or RSSI or a higher half-power beam width,
a change in a list indicating for a plurality of beams the m best beams (top-m list of beams) and/or the m worst beams (worst-m list of beams), e.g., in terms of signal power and/or interference,
UE 570 predicts a movement of UE 580,
UE 570 predicts a better beam, e.g., to continue an angular shift of the beam,
receipt of assistance information, e.g., AIMs or higher layer assistance information, like a Cooperative Awareness Message, CAM, or a Decentralized Environmental Notification Message, DENM, comprising, e.g., one or more of: a velocity, a direction, an angle, a distance, a position, an acceleration, a future route or a future position of UE 580 providing the assistance information.

FIG. 18 illustrates an embodiment for a beam adjustment when the sidelink UEs are moving relative to each other. It is assumed that the sidelink UEs 570 and 580 communicate with each other over the PC5 interface and that UE 580 moves from a first position at the time instance t0 to a second position at the time instance t1. Initially, UE 570 uses a radiation pattern or beam 566 at the time instance t0 which is pointed towards the UE 580. Responsive to recognizing a movement of the UE 580, UE 570 performs a beam adjustment such that the beam pair link is maintained. For this, UE 570 modifies its beam from beam 566 at the time instance t0 to beam 566′ at time instance t1 so that the transmit beam is pointed into the direction of the UE 580, either directly or via a reflector, such that a pathloss between both UEs is minimized. Although FIG. 18 illustrates an embodiment in which the transmitting UE 570 adjusted its beam due to the movement of UE 580, it is noted that the invention is not limited to such embodiments. Rather, in accordance with other embodiments, instead of UE 570, UE 580 may perform the beam adjustment or, in accordance with yet other embodiments, both UEs may perform the beam adjustment so that the respective beams point to each other.

In accordance with further embodiments, the beam adjustment may be performed based on historic data, e.g., in case a beam was moved into a certain direction for a certain time unit, the beam is moved according to an interpolation into the certain direction, and/or a data model produced, e.g., based on a configured or pre-configured data model or based on an artificial intelligence, AI, model and/or a machine learning, ML, model. The data model may be implemented in the SL-UE or in another entity. In other words, the beam adjustment may be based on a data model produced within one or more of the sidelink UEs, for example based on a configured or pre-configured data model or based on an artificial intelligence, AI, and/or machine learning, ML, model. In case of limited processing power at the UEs, the data model may also be implemented in a third entity or may be calculated by another entity and then downloaded to the respective UEs. For example, the model may be stored inside a network entity, like the base station or the CN network function, or by another higher layer processor and may be stored in the internet.

### General

Embodiments of the present invention have been described in detail above, and the respective embodiments and aspects may be implemented individually or two or more of the embodiments or aspects may be implemented in combination. For example, responsive to providing one or more BMRs according to the first aspect of the present invention, the beam management procedures according to the second and/or third aspects of the present invention may be performed and make use of the information provided in the BMR. Likewise, prior to performing the beam management procedures according to the second and/or third aspects of the present invention, the generation and distribution of one or more BMRs according to the first aspect of the present invention may be triggered so that the information in the BMR may be taken into account when performing the respective beam management procedures.

In accordance with embodiments, the SL-UEs may perform the SL communication simultaneously using carrier aggregation (CA) or by using carrier switching utilizing one or more of
one or more high frequency bands, e.g., in FR2, using resources from a licensed spectrum and/or from an unlicensed spectrum, and/or
one or more low frequency bands, e.g., in FR1, using resources from a licensed spectrum and/or from an unlicensed spectrum.

Carrier aggregation (CA) utilizes more than one carrier simultaneously in the frequency domain. Carrier switching uses certain time resource within one frequency band, e.g., FR1, and in another time instance, resources within another frequency band, e.g., FR2. Carrier switching may save resources, e.g., power consumption in a device, while still allowing to use resources in more than one band. In general, control traffic may be sent very robust on a low frequency carrier, e.g., in FR1, while data exchange may occur on a high frequency carrier, FR2, allowing high data rate transmission in a wider frequency band.

In accordance with embodiments, the wireless communication system may include a terrestrial network, or a non-terrestrial network, or networks or segments of networks using as a receiver an airborne vehicle or a space-borne vehicle, or a combination thereof. Further, the wireless communication system may by a system or network different from the above described 4G or 5G mobile communication systems, rather, embodiments of the inventive approach may also be implemented in any other wireless communication network, e.g., in a private network, such as an Intranet or any other type of campus networks, or in a WiFi communication system.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a Wi-Fi device, like a station (STA), access point (AP), node or mesh node, or mesh point, or Mesh AP, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a Wi-Fi device such as an access point (AP) or mesh node (Mesh AP), or a remote radio head, or an AMF, or a MME, or a SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 19 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A user device, UE, for a wireless communication network,
wherein the UE is a sidelink, SL, UE, and is to communicate with one or more further SL-UEs over a sidelink, SL, using more than one antenna or antenna element,
wherein the UE is served by a base station of the wireless communication network, and
wherein the UE is to be assisted by the base station for one or more beam management procedures.

2. The user device, UE, of claim 1, wherein the UE is to be assisted by the base station in coordinating beam management in terms of one or more of:
beam pairing, e.g., to find beam pair links among the SL-UEs during discovery of neighboring SL-UEs within a required communication range,
beam maintenance,
beam failure recovery.

3. The user device, UE, of claim 1, wherein the UE is to be assisted by the base station in coordinating beam management during
SL discovery, and/or
SL link recovery, and/or
a data exchange over the SL so as to trigger a beam sweep at one or both of a transmitting SL-UE, TX SL-UE, and a receiving SL-UE, RX SL-UE.

4. The user device, UE, of claim 3, wherein the UE is a TX SL-UE or a RX SL-UE, and wherein, in case of a data exchange over the SL, the UE is to send to the base station a request for a beam sweep at one or more other SL-UEs, the request causing the base station to trigger a beam sweep at the one or more other SL-UEs, wherein the request may be included in a control signal or in a scheduling request, SR.

5. The user device, UE, of claim 3, wherein, in case of a data exchange over the SL, the UE is to
receive a distribution of a beam sweep configuration to adjust transmissions over two or more transmit antennas of both the TX SL-UE and the RX SL-UE, wherein the beam sweep configuration may include a pre-coder configuration, timing, or frequency information, or
transmit assistance information, AIM, the AIM including beam coordination information, wherein the beam coordination information may include a pre-coder configuration, timing, or frequency information.

6. The user device, UE, of claim 1, wherein
the UE is to communicate with the further SL-UEs in a first frequency band, e.g., in one of a high frequency band, like FR2, and a low frequency band, like FR1, and
the UE is to be assisted by the base station in performing beam management procedures in a second frequency band, e.g., in the other one of the high frequency band, like FR2, and the low frequency band, like FR1.

7. A base station for a wireless communication network,
wherein the base station is to serve a plurality of sidelink UEs, SL-UEs, communicating with each other over a sidelink, SL, using beamforming, and
wherein the base station is to assist one or more of the SL-UEs in beam management procedures.

8. The base station of claim 7, wherein the base station is to assist in coordinating beam management in terms of one or more of:
beam pairing, e.g., to find beam pair links among the SL-UEs during discovery of neighboring SL-UEs within a required communication range,
beam maintenance, e.g., for keeping the beams aligned,
beam failure recovery.

9. The base station of claim 7, wherein the base station is to assist in coordinating beam management during
SL discovery, and/or
SL link recovery, and/or
a data exchange over the SL so as to trigger a beam sweep at one or both of a transmitting SL-UE, TX SL-UE, and a receiving SL-UE, RX SL-UE.

10. The base station of claim 9, wherein, in case of a data exchange over the SL, the base station is to
receive from one of the SL-UEs a request for a beam sweep at one or more other SL-UEs, wherein the request may be included in a control signal or in a scheduling request, SR, and
responsive to the request, trigger a beam sweep at the one or more other SL-UEs, and
wherein the request is signaled by a TX SL-UE or by a RX SL-UE.

11. The base station of claim 9, wherein, in case of a data exchange over the SL, the base station is to cause
a distribution of a beam sweep configuration to adjust transmissions over multiple transmit antennas of both the TX SL-UE and the RX SL-UE, wherein the beam sweep configuration may include a pre-coder configuration, timing, or frequency information, or
a transmission of assistance information, AIM, among the TX SL-UE and the RX SL-UE, the AIM including beam coordination information, wherein the beam coordination information may include a pre-coder configuration, timing, or frequency information.

12. The base station of claim 7, wherein
the plurality of sidelink UEs, SL-UEs, communicate with each other over a sidelink, SL, using more than one antenna or antenna element in a first frequency band, e.g., in one of a high frequency band, like FR2, and a low frequency band, like FR1, and
the base station is to assist the one or more of the SL-UEs in performing beam management procedures in a second frequency band, e.g., in the other one of the high frequency band, like FR2, and the low frequency band, like FR1.

13. A user device, UE, for a wireless communication network,
wherein the UE is a sidelink, SL, UE, and is to communicate with one or more further SL-UEs over a sidelink, SL, using more than one antenna or antenna elements,
wherein the UE is to perform beam sweeping using a beam sweeping signal.

14. The user device, UE, of claim 13, wherein the UE is to transmit a communication request within the beam sweeping signal.

15. The user device, UE, of claim 14, wherein, responsive to successfully receiving a communication response from a target SL-UE, the UE is to
determine matching beams of the UE and the target SL-UE, and/or
retain at least one beam pair link for a communication between the first SL-UE A and the second SL-UE.

16. A user device, UE, for a wireless communication network,
wherein the UE is a sidelink, SL, UE, and is to communicate with one or more further SL-UEs over a sidelink, SL, using more than one antenna or antenna elements,
wherein the UE is to receive from at least one of the further SL-UEs a beam sweeping signal.

17. The user device, UE, of claim 16, wherein the UE is to receive a communication request from the further SL-UE, the communication request being included within the beam sweeping signal.

18. The user device, UE, of claim 16, wherein, responsive to successfully receiving the beam sweeping signal by the further SL-UE, the UE is to transmit a communication response including relevant information, the relevant information including one or more of:
a beam ID,
a UE ID, e.g., source and/or destination ID,
a type of UE, e.g., source and/or destination type, such as vehicular UE, RSU, P-UE,
a CSI feedback,
a type of sweeping signal, e.g., reference signals and/or beam pattern used,
UE capabilities, e.g., which features are supported such as maximum rank, peak data rate, supported codebooks,
a time slot of a matching beam, e.g., a time instance when a beam pair link may be established,
a frequency resource, e.g., a subchannel where a beam pair link may be established.

19. A wireless communication network, comprising:
a plurality of sidelink UEs, SL-UEs, communicating with each other over a sidelink, SL, using more than one antenna, e.g., using beamforming, the plurality of SL-UEs comprising a first SL-UE according claim 13 and a second SL-UE according to claim 16,
wherein the first SL-UE is to perform beam sweeping using a beam sweeping signal and transmit a communication request within the beam sweeping signal.

20. The wireless communication network of claim 19, wherein the first and second SL-UEs are synchronized with a time reference, and the first and second SL-UEs use the time reference for pointing to one or more time slots where beams transmitted by the first and second SL-UEs are matching.

21. The wireless communication network of claim 20, wherein the time reference is one of the following
an external time reference, e.g., GPS,
a network time reference, e.g., a time reference taken from a base station, a core network, CN, or from another server form the Internet,
a sidelink synchronization signal, SLSS,
a UE operating as a time reference, e.g., a transmitter UE being used as a time reference or for giving a relative time for the request sent by a UE.

22. A user device, UE, for a wireless communication network,
wherein the UE is a sidelink, SL, UE, and is to communicate with one or more further SL-UEs over a sidelink, SL, using more than one antenna or antenna elements,
wherein the UE is to communicate with at least one of the further SL-UEs over the sidelink, SL, using matching beams of the UE and the further SL-UE, and
wherein, responsive to a certain event, the UE is to perform a beam adjustment, e.g., such that a matching of the beam of the UE and the further SL-UE is maintained.

23. The user device, UE, of claim 22, wherein, to perform the beam adjustment, the UE is to modify its beam from a first beam to a second beam, e.g., such that its beam is pointed into the direction of the further SL-UE, either directly or via a reflector.

24. The user device, UE, of claim 22, wherein the beam adjustment is performed responsive to one or more of the following events:
the further SL-UE moves from a first position at a first time instance to a second position at a second time instance,
the further SL-UE indicates a degradation, e.g., according to a power measurement of the beam,
the UE determines, responsive to a beam sweep or a reduced beam sweep testing neighboring side lobes of a main beam, a new main beam,
the further SL-UE reports a new beam having a higher power and/or less interference, e.g., a higher SINR or SNR or RSSI or a higher half-power beam width,
a change in a list indicating for a plurality of beams the m best beams (top-m list of beams) and/or the m worst beams (worst-m list of beams), e.g., in terms of signal power and/or interference,
the UE predicts a movement of the further SL-UE,
the UE predicts a better beam, e.g., to continue an angular shift of the beam,
receipt of assistance information, e.g., AIMs or higher layer assistance information, like a Cooperative Awareness Message, CAM, a Decentralized Environmental Notification Message (DENM) message comprising, e.g., one or more of: a velocity, a direction, an angle, a distance, a position, an acceleration, a future route, or a future position of the further SL-UE providing the assistance information.

25. The user device, UE, of claim 22, wherein the beam adjustment is to be performed based on
historic data, e.g., in case a beam was moved into a certain direction for a certain time unit, the beam is moved according to an interpolation into the certain direction, and/or
a data model produced, e.g., based on a configured or pre-configured data model or based on an artificial intelligence, AI, model and/or a machine learning, ML, model.

26. The user device, UE, of claim 25, wherein the data model is implemented
in the SL-UE, or
in another entity so as to be downloaded onto the SL-UE, the other entity comprising, e.g., a network entity, like a gNB or core network, CN, network function, NF, or another higher layer processor storing the data model, e.g., in the Internet.

27. A wireless communication network, comprising:
a plurality of sidelink UEs, SL-UEs, communicating with each other over a sidelink, SL, the plurality of SL-UEs comprising a first SL-UE according to claim 22 and a second SL-UE communicating with each other over the SL using matching beams transmitted by the first and second SL-UEs, and
wherein, responsive to a certain event, one or both of the first and second SL-UEs are to perform a beam adjustment such that a matching of the beams transmitted by the first and second SL-UEs is maintained.

28. The user device, UE, or the network entity or the wireless communication network of any one of claims 1, 13, 16, 19, 22, 27, wherein the SL-UEs perform the SL communication in a high frequency band, e.g., in FR2, using resources from a licensed spectrum and/or from an unlicensed spectrum.

29. The user device, UE, or the network entity or the wireless communication network of any one of claims 1, 13, 16, 19, 22, 27, wherein the SL-UEs perform the SL communication simultaneously using carrier aggregation (CA) or by using carrier switching utilizing
a high frequency band, e.g., in FR2, using resources from a licensed spectrum and/or from an unlicensed spectrum, and
a low frequency band, e.g., in FR1, using resources from a licensed spectrum and/or from an unlicensed spectrum.

30. The user device, UE, or the network entity or the wireless communication network of any one of claims 1, 13, 16, 19, 22, 27,
wherein the UE comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a Wi-Fi device, station, access point, node or mesh node, or mesh point, or Mesh AP, or any sidelink capable network entity, and
wherein the network entity of the wireless communication system comprises one or more of the following:
a base station, like a macro cell base station, or a small cell base station, or a central unit of a base station, or a distributed unit of a base station, or an Integrated Access and Backhaul, IAB, node, or a Wi-Fi device such as an access point or mesh node,
a road side unit, RSU,
a UE, like a SL UE, or a group leader UE, GL-UE, or a relay UE,
a remote radio head,
a core network entity, like an Access and Mobility Management Function, AMF, or a Service Management Function, SMF, or a mobile edge computing, MEC, entity,
a network slice as in the NR or 5G core context,
any transmission/reception point, TRP, enabling an item or a device to communicate using the wireless communication network, the item or device being provided with network connectivity to communicate using the wireless communication network,

31. A wireless communication system, e.g., a 3^{rd} Generation Partnership Project, 3GPP, system or a WiFi communication system, comprising the user device, UE, and/or the network entity of any one of claims 1, 13, 16, 19, 22, 27.

32. A method for operating a user device, UE, for a wireless communication network, the method comprising:
communicating, by the UE which is a sidelink, SL, UE, SL-UE, being served by a base station of the wireless communication network, with one or more further SL-UEs over a sidelink, SL, using more than one antenna or antenna element, and
assisting the UE, by the base station, with one or more beam management procedures.

33. A method for operating a base station for a wireless communication network, the method comprising:
serving, by the base station, a plurality of sidelink UEs, SL-UEs, communicating with each other over a sidelink, SL, using beamforming, and
assisting, by the base station, one or more of the SL-UEs in beam management procedures.

34. A method for operating a user device, UE, for a wireless communication network, the method comprising:
communicating, by the UE which is a sidelink, SL, UE, SL-UE, with one or more further SL-UEs over a sidelink, SL, using more than one antenna or antenna element, and
performing, by the UE, a beam sweeping using a beam sweeping signal.

35. A method for operating a user device, UE, for a wireless communication network, the method comprising:
communicating, by the UE which is a sidelink, SL, UE, SL-UE, with one or more further SL-UEs over a sidelink, SL, using more than one antenna or antenna element, and
receiving, by the UE, from at least one of the further SL-UEs a beam sweeping signal.

36. A method for operating a user device, UE, for a wireless communication network, the method comprising:
communicating, by the UE which is a sidelink, SL, UE, SL-UE, with one or more further SL-UEs over a sidelink, SL, using more than one antenna or antenna element, wherein the UE communicates with at least one of the further SL-UEs over the sidelink, SL, using matching beams of the UE and the further SL-UE, and
responsive to a certain event, performing, by the UE a beam adjustment, e.g., such that a matching of the beam of the UE and the further SL-UE is maintained.

37. A non-transitory computer program product comprising a computer readable medium storing instructions which, when executed on a computer, perform the method of any one of claims 32 to 36.
